(19) United States
(12) Patent Application Publication
(10) Pub. No.: US 2026/0320058 A1
(43) Pub. Date: Oct. 15, 2026

(54) GENEALOGICAL AUTONOMOUS-DECISION FRAMEWORK

(71) Applicant: Ancestry.com Operations Inc., Lehi, UT (US)

(72) Inventors: Robert Weis, Oakland, CA (US); Gann Bierner, Oakland, CA (US); Glen Brewer Lewis, Lehi, UT (US); Samuel Mark Mefford, Pleasant Grove, UT (US); Herrick Gordon Muhlestein, Ephraim, UT (US); Vasilii Yevgenyevich Urdenko, San Jose, CA (US); Benjamin James Busath, Chicago, IL (US)

(21) Appl. No.: 19/174,550

(22) Filed: Apr. 9, 2025

(51) Int. Cl. G06F 16/2457; G06F 16/2458; G06F 16/28

(52) U.S. Cl. CPC G06F 16/24575; G06F 16/2471; G06F 16/288

(57) ABSTRACT

The present disclosure is directed toward systems, methods, and non-transitory computer-readable media for genealogical autonomous-decision framework that orchestrates one or more task sub-graphs to generate a response to a query. The disclosed systems can utilize a classifier node of the genealogical autonomous-decision framework determine a query classification for a query. Based on determining the query classification, the disclosed systems can utilize a routing controller of the genealogical autonomous-decision framework to provide the query to a corresponding task sub-graph according to the query classification. The disclosed systems can utilize a large language model corresponding to the task sub-graph to generate an instruction enabling a task adapter corresponding to the genealogical autonomous-decision framework to generate a response to the query.

### BACKGROUND

Recent years have seen significant developments in artificial intelligence (AI) software and use of large language models across an enormous array of tasks, including generating, summarizing, translating, and classifying digital content. Based on the ever-increasing capabilities of large language models, some existing systems integrate large language models into programming architecture, data analysis pipelines, or other data processing systems. For example, some existing systems use large language models to search genetic databases that contain billions of data records (e.g., genealogical content items). Despite these advances, existing systems exhibit a number of problems, particularly in relation to operational flexibility, efficiency, and accuracy.

As just suggested, many existing genealogical data systems are operationally inflexible. While existing systems may incorporate large language models into programming architectures or data analysis pipelines, such incorporation is generally done in a piecewise fashion with each model siloed to its own specific task or context, separate from other tasks or contexts. To implement or apply the large language models in such siloed architectures, many existing systems require specialized expertise on the part of the user to perform genealogical research through complicated processes (e.g., involving sophisticated knowledge of data inputs) to access, use, and generate data for implementing any models that might be available. Thus, not only are existing systems inflexible in terms of their siloed structures which prevent adaptation across various contexts, but existing systems are further inflexible in their complex implementation which inhibits or reduces use by large numbers of user accounts.

Due at least in part to their operational inflexibility, many existing genealogical data systems are computationally inefficient. The siloed nature of existing systems requires navigation among multiple applications and interfaces, sometimes even across multiple devices, to access models and data involved in a single genealogical research project. Running the various applications and processing the interactions for navigating among the applications and interfaces utilizes excessive amounts of computational resources, such as processing power, memory, and storage. In some cases, the siloed nature of existing systems often requires multiple large language models to repetitively tokenize redundant conversations (and/or other data that could otherwise be shared) for a single genealogical research project, as each model performs its own specific task. The inability of existing genealogical systems to share data among large language models causes further expenditure of computational resources (such as processing power, memory, and storage) that could otherwise be preserved with a more efficient system.

In addition, many existing genealogical data systems are inaccurate. Specifically, existing large-language-model-based systems often generate inaccurate content due to tokenizing and re-tokenizing large amounts of data. For example, the tokenization process can cause existing large-language-model-based systems to lose context, especially where large amounts of data are concerned, and the loss of context can not only negatively impact the accuracy or results generated by the large language models but can also result in the models re-tokenizing repeated or redundant contextual data. Additionally, many existing systems use large language models that depend on a generalized database that includes vast amounts of data across a huge variety of topics and fields. If the database is incomplete, biased, or sparse on particular content, the large language model often generates responses poorly tailored to specific tasks or contexts, and which are sometimes inaccurate and/or irrelevant. Unfortunately, a consequence of such wide-ranging and generalized training (on sometimes biased data) is that the resulting large language models often hallucinate, generating erroneous, irrelevant, or incorrect responses (or other outputs) that the models treat as true. Without ways to ameliorate the inaccurate outputs generated by existing large language models, many conventional systems produce unreliable outputs, especially in specific domains such as genealogical data, which negatively affect downstream analysis and/or use of such outputs.

### SUMMARY

This disclosure describes one or more embodiments of systems, methods, and non-transitory computer-readable storage media that provide benefits and/or solve one or more of the foregoing and other problems in the art. In particular, the disclosed systems utilize a genealogical autonomous-decision framework to direct queries received from a user account to specialized task sub-graphs within the genealogical autonomous-decision framework to generate responses and/or perform tasks responsive to the query. Specifically, the disclosed systems utilize a classifier node of the genealogical autonomous-decision framework to determine a classification for a received query. Based on the query classification, the disclosed systems provide the query to a corresponding task sub-graph within the genealogical autonomous-decision framework. In some embodiments, the disclosed systems can use function adapters corresponding to task sub-graphs to execute tasks and/or generate or otherwise extract genealogical data to inform large language models in generating a response for the query. Indeed, the disclosed systems can utilize retrieval augmentation, such as retrieval-augmented generation (RAG) or retrieval-augmented thought (RAT), to augment or otherwise supplement processes corresponding to the genealogical autonomous-decision framework, such as routing queries to corresponding task sub-graphs, generating instructions for function adapters, and/or generating responses to queries based on genealogical data.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a schematic diagram of an example environment of a genealogical agentic system in accordance with one or more embodiments.

FIG. 2 illustrates an overview of utilizing a genealogical autonomous-decision framework to generate a response to receiving a query in accordance with one or more embodiments.

FIG. 3 illustrates a block diagram of a genealogical autonomous-decision framework in accordance with one or more embodiments.

FIG. 4 illustrates a genealogical agentic system determining a plurality of tasks from a query in accordance with one or more embodiments.

FIG. 5 illustrates a genealogical agentic system utilizing a plurality of large language models in accordance with one or more embodiments.

FIG. 6 illustrates a genealogical agentic system utilizing retrieval augmented thought model and/or a retrieval augmented generation to augment a chain of thought process of a large language model within a genealogical autonomous-decision framework in accordance with one or more embodiments.

FIG. 7 illustrates a genealogical agentic system extracting a plurality of attributes from a tree person and determining a plurality of impactfulness scores corresponding to the plurality of attributes in accordance with one or more embodiments.

FIG. 8 illustrates a genealogical agentic system extracting a plurality of tasks from a query and assigning the plurality of tasks to task sub-graphs according to respective query classifications for the tasks in accordance with one or more embodiments.

FIG. 9 illustrates a genealogical agentic system providing genealogical data within a user interface of a client device in accordance with one or more embodiments.

FIG. 10 illustrates a tree database and a cluster database of the genealogical agentic system in accordance with one or more embodiments.

FIG. 11 illustrates an example series of acts for generating a response to a query in accordance with one or more embodiments.

FIG. 12 illustrates an exemplary computing system in accordance with one or more embodiments.

FIG. 13 illustrates an exemplary computing environment in accordance with one or more embodiments.

### DETAILED DESCRIPTION

This disclosure describes one or more embodiments of a genealogical agentic system that can utilize a genealogical autonomous-decision framework to generate responses to genealogical queries and/or to automatedly perform genealogical research tasks (e.g., for modifying genealogical trees, updating available genealogical content items stored in a genealogy database, identifying tree persons corresponding to genealogical content items, and/or searching among stored genealogical content items). In practical scenarios, the genealogical agentic system can aid in (and enhance) genealogical research by providing a foundational framework for additional capabilities not previously found in genealogy data systems and by guiding researchers through discovery and application of such newfound capabilities, even in situations where researchers have exhausted previously available research functions and/or do not know where to further advance their genealogy research. The genealogical agentic system can provide such improved genealogy research functions by providing straightforward interface elements, such as chat interfaces and other tools, for receiving user queries that can range from open-ended questions to freeform text to specifically parameterized function requests. From a user query, the genealogical agentic system can generate and provide responses and/or can execute tasks within a genealogical data system environment by using the genealogical autonomous-decision framework to intelligently access relevant data and implement appropriate models. Thus, by using the unique genealogical autonomous-decision framework, the genealogical agentic system can generate and provide responses (and/or can otherwise execute tasks to modify genealogical tree nodes, generate hints, or perform other tasks) for complex genealogical queries in an intuitive interface that is accessible and understandable even to novice users.

To illustrate, the genealogical agentic system can utilize a classifier node of the genealogical autonomous-decision framework to determine a query classification for a query received through a user interface of a client device. Based on the query classification, the genealogical agentic system can use a routing controller to provide the query to a task sub-graph within the genealogical autonomous-decision framework. While reference is made to sub-graphs throughout this disclosure, the term “sub-graph” can refer to other types of software constructs that manage, apply, modify, and fine-tune large language models (and their respective function adapters) either within or independent of an overarching architectural framework including a plurality of such software constructs (working together or independent of one another).

Further, in some embodiments, the genealogical agentic system can parse or dissect the query to determine a plurality of tasks from the query. Based on determining the plurality of tasks, the genealogical agentic system can utilize the classifier node to determine a plurality of respective query classifications for the plurality of tasks. Moreover, the genealogical agentic system can utilize the routing controller to provide tasks to corresponding task sub-graphs in parallel and/or in series. Additionally, the genealogical agentic system can utilize the routing controller to orchestrate an order of completion of the tasks. Further, the genealogical agentic system can combine responses to tasks into a cohesive query response to provide to the user account via the user interface.

In addition, the genealogical agentic system can use retrieval augmentation, such as retrieval-augmented generation (RAG) or retrieval-augmented thought (RAT), to augment one or more operations of the genealogical autonomous-decision framework. For example, the genealogical agentic system can search a repository of RAT store items that include text descriptions of tuning data interpretable by the large language model to inform or augment its internal parameters for how to process data or execute functions (e.g., its chain of thought). For example, the RAT store items can include expert-generated instruction sets and/or examples of generated responses specific to the received prompt or task. The genealogical agentic system can further utilize the large language model to execute processes defined by the text descriptions in an identified RAT store item (e.g., by executing processes indicated by text descriptions of processes in an instruction set or by generating a response matching a provided example corresponding to the prompt).

As suggested above, the genealogical agentic system provides several improvements over conventional systems. For example, the genealogical agentic system can improve operational flexibility over prior systems. Through its genealogical autonomous-decision framework, the genealogical agentic system flexibly adapts queries (or discrete tasks extracted from queries) to sub-graphs or models (e.g., large language models) capable of generating responses to the queries or executing the tasks as part of an overarching architectural framework that orchestrates execution of tasks using respective sub-graphs. Thus, rather than requiring several separately siloed systems (which may be difficult or impossible to make compatible with one another in shared workflows) to perform individual genealogy research tasks, the genealogical agentic system can utilize a single harmonized architecture-the genealogical autonomous-decision framework-that orchestrates task execution across sub-graphs. The genealogical autonomous-decision framework can include a classifier node and a routing controller to classify and route queries (or tasks) to corresponding sub-graphs.

Not only does the genealogical agentic system use a single framework to flexibly adapt queries to the proper sub-graphs (and their constituent models and function adapters), but the genealogical agentic system further uses the single framework to adapt the application and accessibility of the models to a wider range of user accounts. The genealogical agentic system thus facilitates complex genealogical research tasks even for novices or others without sophisticated understanding of models and how to adapt data from one model to the next as part of a genealogical research workflow. Indeed, unlike prior systems that require expert knowledge of model parameters to perform a genealogical research workflow that involves multiple models, the genealogical agentic system automatedly adapts workflows to proceed from one model to the next (adapting payloads and data as necessary for compatibility).

Due at least in part to improving flexibility, the genealogical agentic system also increases computational efficiency over prior systems. By utilizing a classifier node and a routing controller of the genealogical autonomous-decision framework to classify and route a query (or its tasks), the genealogical agentic system can automatedly (e.g., without user interaction) implement multiple models within a workflow to generate a response or execute a task. In some cases, the genealogical agentic system provides a single touchpoint (e.g., a chat interface) for interacting with the genealogical autonomous-decision framework with text-based interactions, thus circumventing the intricacies of prior interfaces that include tens or hundreds of selectable options for setting up parameters for, and applying, various models as part of a genealogical research workflow (e.g., where each model in the workflow may have its own separate and equally complicated interface).

Through the intuitive, text-based query interface, the genealogical agentic system further circumvents the onerous computational requirements of running (and navigating between) multiple separate applications and caching interface data for many different interfaces for utilizing respective models as part of a workflow. Accordingly, the genealogical agentic system not only simplifies and reduces the user interactions for performing genealogy research workflows, but also preserves computational resources (e.g., processing power, memory, and/or storage) compared to prior systems that facilitate such a complicated series of interfaces.

In some embodiments, the genealogical agentic system further preserves computational resources by intelligently passing tokenized data among models within the genealogical autonomous-decision framework. In cases where a genealogy research workflow involves multiple models, where the output of one model serves as (part of the) input to another downstream model, or where a single model is implemented multiple times, the genealogical agentic system can preserve tokenized context for the downstream model. Indeed, by implementing models using sub-graphs as part of a genealogical autonomous-decision framework, the genealogical agentic system can pass tokenized data among sub-graphs and/or can preserve tokenized data for a repeated sub-graph. Thus, compared to prior systems that require repeated queries and/or redundant tokenization due to implementing models housed in separate systems or applications, the genealogical agentic system consumes fewer computational resources by processing fewer queries and performing fewer tokenization operations.

Further, the genealogical agentic system can improve accuracy over prior systems. By utilizing a classifier node and a routing controller to classify and route queries (or tasks) to task sub-graphs within the genealogical autonomous-decision framework, the genealogical agentic system generates responses using models specially adapted to their queries or tasks. Rather than providing a query to an overgeneralized model as in some prior systems, the genealogical agentic system can assign a query or task to a specific task sub-graph corresponding to a model specially adapted to the query classification (e.g., adapted using a function adapter). By further breaking a query down into more granular tasks, and by determining task sub-graphs within the genealogical autonomous-decision framework suited to perform such tasks, the genealogical agentic system can generate more accurate responses to queries compared to systems that provide entire queries to generalized models.

As illustrated by the foregoing discussion, the present disclosure utilizes a variety of terms to describe features and benefits of the genealogical agentic system. Additional detail is hereafter provided regarding the meaning of these terms as used in this disclosure. Further, while this disclosure focuses primarily on genealogical content in the context of a genealogical data system, the genealogical agentic system can perform one or more of the processes described herein in the context of other types of digital content items and data systems as well.

As used herein, the term “genealogical autonomous-decision framework” refers to a pluggable, adaptive, autonomous machine learning architecture for assigning models and generating responses to queries. The genealogical autonomous-decision framework can form a graph which includes a classifier node, a routing controller, one or more task sub-graphs (which can be modified, added, and/or removed), and a persistence layer that are interconnected by edges indicated relatedness to one another and/or a flow of execution from one component to the next (where the edges update and adapt to new queries to indicate different execution flows). Specifically, the genealogical autonomous-decision framework can be a framework for building a computer application or subroutine that utilizes one or more specialized genealogical large language models to generate responses to queries received though a user interface of a client device. The genealogical autonomous-decision framework can be a graph of interconnected sub-graphs that perform dynamic workflows. For example, each of the sub-graphs in the genealogical autonomous-decision framework can represent or include respective models (e.g., large language models) for executing respective processing steps or tasks in a workflow, such as determining intent for a user account, querying a genealogical database to search genealogical content items, calling an API, generating a response, etc. Further, the sub-graphs in the genealogical autonomous-decision framework can be connected by edges that define relationships between the sub-graphs, such as one sub-graph relying on data generated by another sub-graph (where some nodes or processes are executable in series and others executable in parallel) and/or where sub-graphs execute tasks corresponding to a shared query classification.

As used herein, the term “classifier node” can refer to a component of the genealogical autonomous-decision framework that functions as a decision-making unit to determine tasks to execute (and their order). In certain embodiments, a classifier node classifies queries and/or tasks extracted from queries. In some embodiments, the classifier node can utilize heuristics (e.g., predefined rules, pattern recognition, and/or probabilistic estimates) to determine the query classifications. In some embodiments, the classifier node can use rule-based logic (e.g., explicit if-then conditions) to classify queries. Further, in some embodiments, the classifier node can use statistical classification (e.g., logistic regression or decision trees) to classify queries. Additionally, in some embodiments, the classifier node can use semantic similarity matching (e.g., converting input text into vector representations and comparing the vector representations against stored embeddings) to classify queries. In one or more embodiments, the classifier node can include or refer to one or more machine-learning classifiers, such as a neural network trained to classify queries and/or extracted tasks.

Additionally, in some embodiments, the classifier node can be a large-language model that the genealogical agentic system can fine-tune or otherwise configure to receive, as an input, the user query and generate, as an output, a classification. For example, the genealogical agentic system can train or otherwise fine-tune the classifier node to identify and/or extract relevant features from the query using embeddings or heuristics and to determine classifications from the relevant features. To illustrate, the genealogical agentic system can fine-tune a large language model to be a classifier node using a query classification dataset to provide domain-specific classification. Further, the genealogical agentic system can fine-tune the classifier node to utilize context and/or historical data to clarify ambiguous queries received from a user account. In some embodiments, the genealogical agentic system can train or otherwise fine-tune the classifier node to generate query classifications through a multi-stage classification process that can include combinations of heuristic and rule-based filtering, embedding searches (e.g., context-aware matching), large-language-model-based classification, confidence validation, and/or requesting user account clarifications (e.g., through subsequent or follow-up queries).

Further, as used herein, the term “routing controller” can refer to a component of the genealogical autonomous-decision framework that the genealogical agentic system uses to orchestrate workflows for queries or tasks. For example, the genealogical agentic system can use the routing controller to determine or assign a task sub-graph within the genealogical autonomous-decision framework to generate a response to a query and/or to complete a task indicated by a query. Further, the genealogical agentic system can use the routing controller to determine a workflow for a query (e.g., an order of completion for tasks corresponding to the query) provided to the genealogical autonomous-decision framework, where the workflow includes executing multiple tasks in order (and/or in parallel) by passing data among nodes until ultimately generating a response or executing a final task. For example, the genealogical agentic system can use the routing controller to support parallel processing among task sub-graphs in the genealogical autonomous-decision framework, enabling multiple task sub-graphs to execute independent tasks simultaneously. Further, the genealogical agentic system can use the routing controller to synthesize responses generated by task sub-graphs into a comprehensive response to provide to the user account (e.g., through a graphical user interface on a client device).

Additionally, as used herein, the term “task sub-graph” can refer to one or more processing units that form a discrete, reusable, modular software construct of the genealogical autonomous-decision framework for managing, applying, modifying, and/or fine-tuning a model (e.g., a large language model) using a corresponding function adapter for executing a task (e.g., a task corresponding to a particular query classification). The task sub-graph can be a collection of processing units, such as a collection of nodes that handle respective operations connected by edges defining the execution order of the nodes (or the node-specific operations). The genealogical agentic system can use a task sub-graph to perform tasks related to queries. For example, the genealogical agentic system can use a task sub-graph to perform tasks such as data transformation, embedding generation, feature extraction, language translation, relationship determination, temporal determination, database querying, vector searching, API calling, web scraping, among others. In addition, a task sub-graph can correspond to a genealogical large language model which the task sub-graph can implement to complete tasks. In some cases, a task sub-graph includes or represents a large language model adapted to a specific task or context.

Indeed, a task sub-graph can correspond to or communicate with a “function adapter,” which can adapt a large language model to its task or context by extracting data from relevant databases (e.g., by executing calls to APIs) and/or which can facilitate completion of tasks external to the genealogical autonomous-decision framework (e.g., by executing calls to APIs). In some cases, a task adapter is a set of heuristics (e.g., logical rules or programmed subroutines), a neural network (e.g., a large language model), or a combination thereof which can execute tasks, call APIs, and/or extract data for adapting nodes. Additionally, in some embodiments, a function adapter can include or otherwise perform one or more functionalities of a geographic information system that maps specific types of data and/or specific types of data requirements to a specific geographic location.

Further, as used, herein, the term “persistence layer” can refer to a component of the genealogical autonomous-decision framework that the genealogical agentic system utilizes to retain state across multiple interactions and/or multiple sessions. For example, the persistence layer can be a combination of memory types, (managed by sub-graphs or nodes) including short-term memory, long-term memory, and session tracking. The persistence layer can also perform context retrieval (e.g., using one or more sub-graphs or nodes) to retrieve previously stored context or progress along a genealogical research workflow. The genealogical agentic system can use the persistence layer to store temporary session data (e.g., user account preferences for a conversation), historical interactions for future reference, manage user sessions to provide continuity across multiple requests/queries, and/or to determine and retrieve relevant prior exchanges to provide context-aware responses. The genealogical agentic system can thus use the persistence layer to save a genealogical research workflow upon detecting a topic or goal change and to continue a previous conversation or genealogical research workflow after detecting a return to a previous topic or goal (or upon instantiating a new genealogical research session).

As used herein, the term “genealogical content item” (or sometimes simply “content item”) refers to a digital object or a digital file that includes information (e.g., genealogical information) interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents, digital images, digital videos, or digital audio files). In some cases, a content item can refer to a genealogical content item that includes or depicts historical or genealogical information, such as a birth certificate, a digitized newspaper article, a digitized photograph of a relative, a digitized census record, a digitized obituary, a digitized court document, a digitized DNA analysis, or a digitized family tree. In some embodiments, a genealogical content item includes a content item selected or identified to surface to a client device, such as an item in a response, a record hint (e.g., a stored or generated genealogical content item surfaced as a suggestion for a user account), a digital story (e.g., a stored collection of genealogical content items arranged for a particular person, topic, or entity of a genealogical data system), a digital image (e.g., a digitized photograph), a new person hint (e.g., a suggested node to add to a genealogical tree), a member tree hint (e.g., a prediction for correcting a node within a genealogical tree of a user account), or a DNA match (e.g., a record indicating a DNA match of a user account to a relative whose information is stored in a genealogical data system).

In some embodiments, the genealogical agentic system generates, stores, and utilizes RAT store items. As used herein, the term “RAT store item” includes or refers to a specific type of content item that is generated by a data expert and that includes text descriptions of instructional data or instructional examples of generated operations (e.g., in a sequence or chain-of-thought) for augmenting chain-of-thought for agentic systems and/or large language models. For example, a RAT store item can include examples of prompts and corresponding sequences of operations generated by a data expert for generating responses to the prompts such that a large language model can analyze the RAT store item to determine how (e.g., a set of functions for processes) to generate a similar output for a similar prompt. As another example, a RAT store item can include text descriptions of an instruction set that, when performed in the indicated sequence, produces a result corresponding to a particular prompt and that, when analyzed by a large language model, enables the large language model to generate and execute corresponding computer processes or functions (e.g., processes/functions corresponding to the text-based instructions) to generate such a result for a prompt. In the field of genealogy, a RAT store item can include a content item generated by a professional genealogist. Example RAT store items include curated instruction sets specific to particular tasks, employee training documents, help videos, hints, genealogical tree data, curated help databases, research journals, and other expert-generated content items for which quality scores can be assigned and evaluated.

In addition, as used herein, the term “machine model” refers to a computer algorithm or a collection of computer algorithms that automatically improve for a particular task through iterative outputs or predictions based on use of data. For example, machine learning model can utilize one or more learning techniques to improve in accuracy and/or effectiveness. Example machine learning models include various types of neural networks, decision trees, support vector machines, and Bayesian networks. In some embodiments, the genealogical agentic system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., responses, data for passing to downstream models, and/or content items) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network. Upon training as described below, such a neural network may become a large language model that generates responses to prompts by interpreting prompt language, accessing additional data from content items, and executing functions indicated by prompts and/or content items.

Further, as used herein, the term “large language model” refers to a machine learning model trained to perform computer tasks to generate or identify content items in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a LLaMA model or a GPT model such as, but not limited to, ChatGPT and its variants.

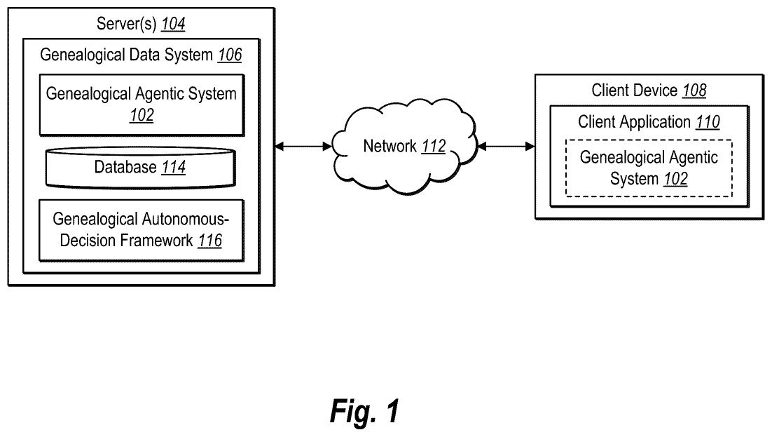

Additional detail regarding the genealogical agentic system will now be provided with reference to the figures. For example, FIG. 1 illustrates a schematic diagram of an example system environment for implementing a genealogical agentic system 102 in accordance with one or more implementations. An overview of the genealogical agentic system 102 is described in relation to FIG. 1. Thereafter, a more detailed description of the components and processes of the genealogical agentic system 102 is provided in relation to the subsequent figures.

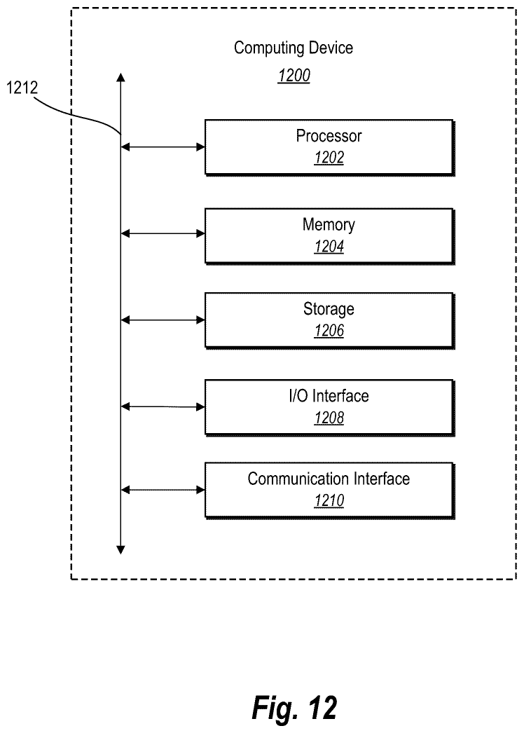

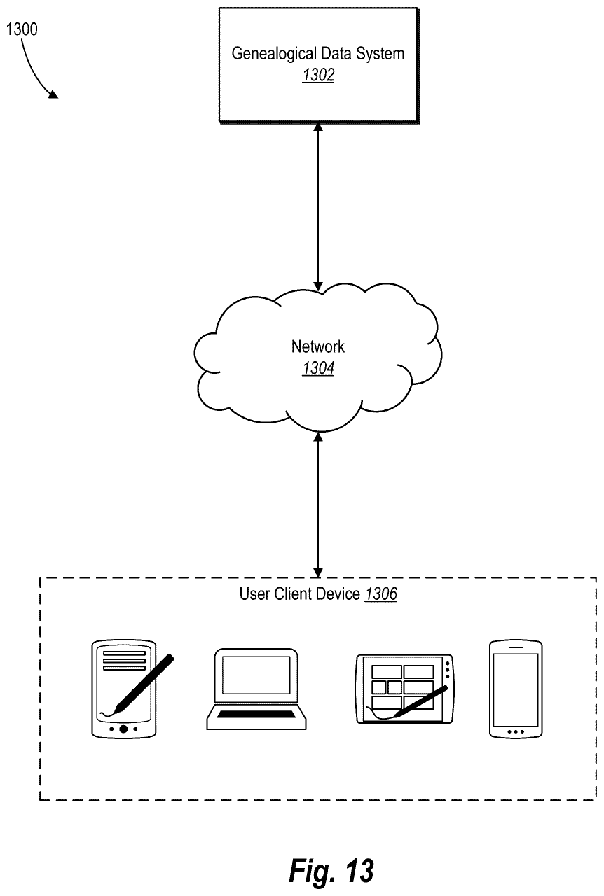

As shown, the environment includes server(s) 104, a client device 108, a database 114, a genealogical autonomous-decision framework 116, and a network 112. Each of the components of the environment can communicate via the network 112, and the network 112 may be any suitable network over which computing devices can communicate. Example networks are discussed in more detail below in relation to FIGS. 12-13.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 12-13. The client device 108 can communicate with the server(s) 104 and/or the database 114 via the network 112. For example, the client device 108 can receive user input from respective users interacting with the client device 108 (e.g., via the client application 110) to, for instance, provide a user query as part of a genealogical research workflow and/or to search for, access, generate, modify, or share a genealogical content item and/or to interact with a genealogical tree or a content item via a graphical user interface of the genealogical data system 106. In addition, the genealogical agentic system 102 on the server(s) 104 can receive information, such as a query relating to various searches for, or interactions with, genealogical content items, and/or user interface elements based on the input received by the client device 108. The genealogical agentic system 102 on the server(s) 104 can further use the genealogical autonomous-decision framework 116 to orchestrate generation of a response to the query by extracting genealogical data from genealogical content items or other sources, such as websites or applications.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a genealogical research interface, a genealogical tree interface, a discover interface for discovering additional genealogical content or discovering relationships among existing genealogical content, or some other graphical user interface, as described herein.

As illustrated in FIG. 1, the example environment also includes the server(s) 104. The server(s) 104 may generate, track, store, process, receive, and transmit electronic data, such as genealogical content items, RAT store items, sub-graph data, prompts, generated responses, and/or interactions with content items. For example, the server(s) 104 may receive data from the client device 108 in the form of a user query and/or a request to modify a genealogy database, to modify a genealogical tree, and/or to perform a search for a genealogical content item. In addition, the server(s) 104 can transmit data to the client device 108 in the form of a response (e.g., data generated by a large language model) within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the genealogical agentic system 102 as part of a genealogical data system 106. The genealogical data system 106 can communicate with the client device 108 to perform various functions associated with the client application 110 such as managing user accounts, managing genealogical data, managing genealogical trees, managing genealogical content items, managing genetic data (e.g., genomes and other DNA-related data) for individuals, and facilitating user interaction with, and sharing of, the genealogical trees, genealogical content items, and genetic data. Indeed, the genealogical data system 106 can include a network-based cloud storage system to manage, store, and maintain genealogical content items and genealogical trees related data user accounts. For instance, the genealogical data system 106 can utilize genealogical data across various content items and user accounts to generate and maintain a universal genealogical tree that reflects the relatedness or consanguinity between nodes corresponding to all user accounts and other individuals indicated by stored genealogical content items. In some embodiments, the genealogical agentic system 102 and/or the genealogical data system 106 utilize the database 114 to store and access information such as genealogical content items, genealogical trees, user account data, and/or other information.

As further illustrated in FIG. 1, the genealogical data system 106 includes a database 114 that stores genealogical content items and/or other data, such as RAT data or RAG data accessible to adapt nodes of the genealogical autonomous-decision framework. In particular, the genealogical agentic system 102 stores the genealogical content items and searches the genealogical content items to generate responses in response to queries. For instance, the genealogical agentic system 102 receives a query from the client device 108 and generates a response that includes one or more (pieces of information from) genealogical content items. In some embodiments, the database 114 also includes a RAT store or a repository of RAT store items that instruct or inform a large language model for performing particular tasks, including accessing and analyzing genealogical content items to generate responses for prompts.

Although FIG. 1 depicts the genealogical agentic system 102 located on the server(s) 104, in some implementations, the genealogical agentic system 102 may be implemented by (e.g., located entirely or in part on) one or more other components of the environment. For example, the genealogical agentic system 102 may be implemented in whole or in part by the client device 108. For example, the client device 108 and/or a third-party system can download all or part of the genealogical agentic system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the genealogical agentic system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

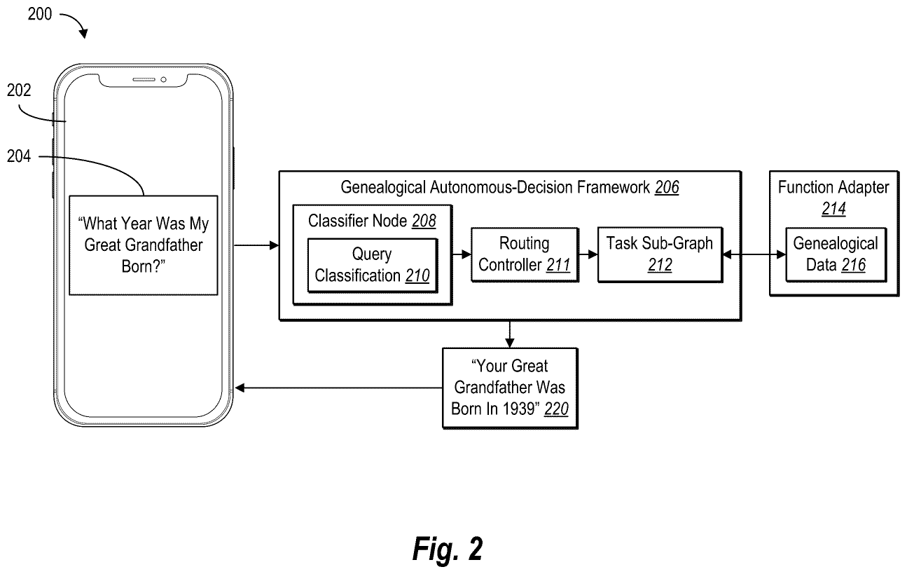

As mentioned above, the genealogical agentic system 102 can utilize a genealogical autonomous-decision framework to generate a response to a query received from a client device and/or to execute tasks associated with the query as part of a genealogical research workflow. FIG. 2 illustrates an example overview of the genealogical agentic system receiving a query, determining a query classification for the query, providing the query to a task sub-graph according to the query classification, and utilizing a large language model to generate or otherwise extract genealogical data to generate a response to the query in accordance with one or more embodiments. Additional detail regarding the various acts and processes introduced in relation to FIG. 2 is provided thereafter with reference to subsequent figures.

As illustrated in FIG. 2, the genealogical agentic system 102 can receive a query 204 (e.g., “What Year Was My Great Grandfather Born?”) from a client device 200 (e.g., as entered or input via a user interface 202). The genealogical agentic system 102 can provide the query 204 to a genealogical autonomous-decision framework 206. The genealogical agentic system 102 can utilize a classifier node 208 of the genealogical autonomous-decision framework 206 to determine a query classification 210 for the query 204. For instance, the classifier node 208 determines the query classification 210 by analyzing the query 204 using natural language processing techniques. Such techniques include tokenizing the query into words (or characters or other sub-words), performing named-entity recognition among the tokens extracted from the query, and applying term-frequency inverse-document-frequency (TF-IDF) weighting to named entities. In some embodiments, the classifier node 208 further performs embedding-based topic detection (or query classification detection) to compare a query embedding of the query 204 with query classification embeddings for candidate query classifications (e.g., by determining distances between the embeddings in embedding space). In some cases, the classifier node 208 employs contextual understanding via attention mechanisms to weight the importance of different words or extracted tokens. The classifier node 208 can also or alternatively determine probabilistic query classifications by assigning probabilities (based on a combination of TF-IDF weighting, embedding distance, and/or contextual understanding) to different query classifications and selecting the query classification 210 (e.g., with the highest probability).

As part of determining the query classification, in some embodiments, the genealogical agentic system 102 determines contextual data associated with a user account of the client device 200 (in accordance with privacy and permission settings of the user account). For example, the genealogical agentic system 102 determines usage patterns of genealogical research interfaces or applications within the genealogical data system 106. In addition, the genealogical agentic system 102 determines a completeness of a genealogical tree associated with the user account (e.g., by comparing the genealogical tree maintained by the user account with a universal genealogical tree maintained by the genealogical data system 106 and/or with genealogical trees of other user accounts), including indications of missing nodes, missing or incorrect information within nodes, and correct/incorrect placement of nodes. In some cases, the genealogical agentic system 102 further determines previous queries, previous conversations, previous genealogical research workflows (and their level of completeness), as well previous clicks or interactions with particular interface elements (e.g., tree nodes, DNA research tools, and search interfaces) for performing genealogical research. The genealogical agentic system 102 can thus generate or extract the aforementioned contextual genealogical data (to form a genealogical research profile) associated with a user account.

Based on determining the query classification 210, the genealogical agentic system 102 can use a routing controller 211 of the genealogical autonomous-decision framework 206 to provide the query 204 to a task sub-graph 212 (identified or selected from among a set of candidate task sub-graphs) of the genealogical autonomous-decision framework 206. In some cases, the routing controller 211 is a subcomponent of the classifier node 208 and functions as part of decision-making process to relay data to sub-graphs. Indeed, the routing controller 211 can execute one or more routing functions to determine the task sub-graph 212 corresponding to (e.g., assigned to execute tasks within) the query classification 210. The routing controller 211 can thus provide the query 204 to the task sub-graph 212 according to the query classification 210. In some cases, the routing controller 211 generates, engineers, augments, or modifies a prompt provided to the task sub-graph 212. To elaborate, the routing controller 211 processes the query 204 to determine a goal (or a set of tasks for achieving a goal) expressed in the query 204 and further generates (for providing to the task sub-graph 212) a prompt that includes instructions and/or computer code parameterizing the tasks for achieving the goal of the query 204.

Based on providing the query 204 to the task sub-graph 212, the genealogical agentic system 102 can cause the task sub-graph 212 to determine a function adapter 214 to generate or otherwise extract genealogical data 216 relating to the query 204. For instance, the task sub-graph 212 can determine the genealogical data 216 that a large language model (of the task sub-graph 212) needs to execute the tasks indicated by the query 204. The genealogical agentic system 102 can thus cause the task sub-graph 212 determine the function adapter 214 as a source of (or a function for identifying the source of and extracting data from) the genealogical data 216 to augment, modify, inform, or supplement the processing of the large language model of the task sub-graph 212. In some cases, the genealogical agentic system 102 determines the function adapter 214 by executing a call to an API or by searching a database, such as a genealogical tree database or a historical records database, to generate or otherwise extract the genealogical data 216 associated with the query 204. Additional detail regarding the task sub-graph and the function adapter 214 is provided below with reference to subsequent figures.

To illustrate by way of an example, the genealogical agentic system 102 can determine that the query classification 210 for the query 204 is “genealogical information,” and can determine the task sub-graph 212 by determining the task sub-graph 212 is assigned to the “genealogical information” query classification and/or that the task sub-graph 212 executes tasks relating to genealogical information. The genealogical agentic system 102 can use the task sub-graph 212 and the function adapter 214 to parse a genealogical tree relating to the user account of the client device 200 to generate or otherwise extract the genealogical data 216. Based on the genealogical data 216, the genealogical agentic system 102 can generate a response 220 to the query 204 using the task sub-graph 212 (e.g., “Your Great Grandfather Was Born In 1939”).

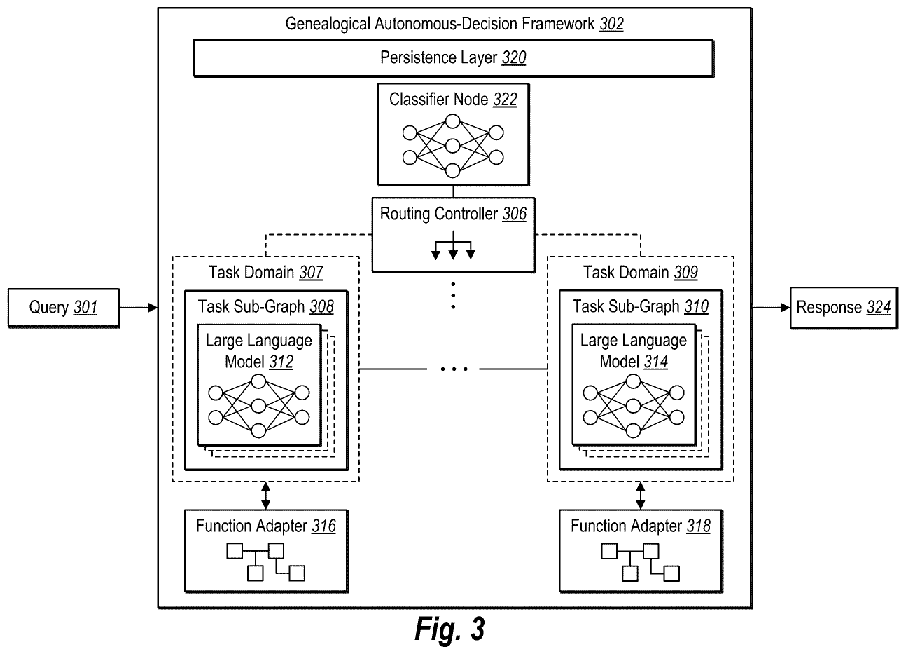

As previously mentioned, the genealogical agentic system 102 can utilize a genealogical autonomous-decision framework 206 to generate a response to a query. FIG. 3 illustrates an example architecture of a genealogical autonomous-decision framework in accordance with one or more embodiments.

As shown in FIG. 3, the genealogical agentic system 102 can utilize a genealogical autonomous-decision framework 302 to generate a response 324 to a query 301 (which process may involve executing multiple tasks using respective sub-graphs). As shown, the genealogical autonomous-decision framework 302 can include an arrangement of task sub-graphs (e.g., including the task sub-graph 308 and the task sub-graph 310, as well as additional task sub-graphs in some embodiments). Indeed, the genealogical agentic system 102 can use the genealogical autonomous-decision framework 302 to generate the response 324 to the query 301 using one or more of the task sub-graphs 308 or 310. For example, the genealogical agentic system 102 can utilize a combination of machine-learning approaches (e.g., using the large language model 312 of the task sub-graph 308) and heuristic approaches (e.g., using a heuristic function of the function adapter 316). In some embodiments, the classifier node 322 executes calls to the function adapter 316 directly (according to a query classification) while in other embodiments the task sub-graph 308 instantiates the function adapter 316.

As part of the process for generating the response 324 (or executing tasks for the query 301), the genealogical agentic system 102 can utilize a classifier node 322 of the genealogical autonomous-decision framework 302 to determine a query classification for the query 301. Indeed, the classifier node 322 can determine a query classification by analyzing the language of the query 301. In some embodiments, the classifier node 322 extracts multiple tasks from the query 301 and determines multiple query classifications for the query 301, each query classification corresponding to a respective task.

The classifier node 322 can further include or coordinate with a routing controller 306 that routes or relays the query 301 (or an extracted task) to a corresponding task sub-graph. In one or more embodiments, the classifier node 322 (and/or the routing controller 306) can ingest or receive multiple queries as part of a conversation between a user and the genealogical autonomous -decision framework 302. From the conversation, the classifier node 322 can extract a series of tasks to execute for generating the response 324. Accordingly, the classifier node 322 can provide a query classification for a task to the routing controller 306, whereupon the routing controller 306 can provide the task to a task sub-graph corresponding to the query classification (or task domain).

Throughout a conversation of a genealogical research workflow, the classifier node 322 (and/or the routing controller 306) can repeatedly determine query classifications for each subsequent query (or for tasks extracted from queries). If the query classification remains constant, the classifier node 322 can continue to provide the queries or tasks to the same task sub-graph. If the query classification changes, however, the classifier node 322 (and/or the routing controller 306) can relay a query to a different sub-graph for the new classification. Upon detecting a change in query classification (or a more global change in the goal of the genealogical research workflow), the genealogical agentic system 102 can use the persistence layer 320 to store conversation data for query classifications as well as execution process toward a goal of the workflow such that, upon detecting a return to the same query classification, the genealogical agentic system 102 can access the data and continue from the stored state (without starting over or losing context) along the genealogical research workflow.

As shown, the routing controller 306 relays a task to the task sub-graph 308 corresponding to the task domain 307 which aligns with a query classification for a task of the query 301. The classifier node 322 (and/or the routing controller 306) can likewise provide additional tasks to respective task sub-graphs for execution (e.g., throughout the conversation). By routing tasks to specific sub-graphs in this fashion, the classifier node 322 (and/or the routing controller 306) prevent individual sub-graphs from needing to parse or process an entire conversation (or even an entire query), instead limiting the sub-graphs to processing the relevant portions for tasks assigned. In cases where a task sub-graph is busy executing another task and/or where one task relies on data generated through execution of another task, the classifier node 322 (and/or the routing controller 306) can distribute tasks to sub-graphs in a sequence or series.

Relatedly, in embodiments where the genealogical agentic system 102 utilizes the task sub-graph 308 and the task sub-graph 310 together (e.g., multiple sub-graphs) to generate the response 324, the genealogical agentic system 102 can maintain different privacy states and/or data payloads between the task sub-graph 308 and the task sub-graph 310. For example, the genealogical agentic system 102 can provide one portion of the query 301 (e.g., for executing a first task) to the task sub-graph 308 and can provide another portion of the query 301 (e.g., for executing a second task) to the task sub-graph 310. The genealogical agentic system 102 can further use the classifier node 322 to selectively provide data to the respective sub-graphs, where each sub-graph is isolated and does not share data (except when passed by the classifier node 322 and/or the routing controller 306 from one sub-graph to the next). The genealogical agentic system 102 can thus reduce the computational expense of tokenization performed by providing different subsets of the query 301 (and/or different queries of a conversation) to the task sub-graph 308 and to the task sub-graph 310, rather than providing the entire query (or the entire conversation to each sub-graph.

Further, as a conversation between the genealogical agentic system 102 and the user account progresses (e.g., where the genealogical agentic system 102 generates the response 324 to the query 301 and receives a follow-on query from the user account), the genealogical agentic system 102 can use the classifier node 322 to provide the follow-on query to an additional task-sub graph. The genealogical agentic system 102 can thus use the classifier node 322 to provide relevant context to the additional task sub-graph (e.g., from the persistence layer 320) to prevent a loss of context of the conversation, even while maintaining separate privacy states between the sub-graphs.

In some embodiments, the genealogical agentic system 102 can use the classifier node 322 to determine an objective of the query 301 (e.g., a goal or intent of the genealogical research workflow). The classifier node 322 can further extract one or more tasks associated with the goal or the objective, and can determine query classifications for the task (or for the query 301 as a whole). The genealogical agentic system 102 can utilize the classifier node 322 to determine the query classification through heuristics, statistical matching, natural language processing, and other machine-learning techniques. In some embodiments, the classifier node 322 can be a large language model that determines the query classification through RAT.

In some embodiments, the genealogical agentic system 102 uses the classifier node 322 to determine that a query is incomplete or that additional information is needed to generate a response or execute a task for the query. If the genealogical agentic system 102 determines that more information is needed to generate a response and/or execute a task corresponding to the query 301, the genealogical agentic system 102 can thus execute an information retrieval task using a large language model to access additional information from one or more databases associated with the user account (per account permissions and privacy settings) using a function adapter and/or to generate follow-up responses to ask for more information directly from the user.

In one or more embodiments, the genealogical agentic system 102 can organize the task sub-graphs of the genealogical autonomous-decision framework 302 (e.g., the task sub-graph 308 and the task sub-graph 310) according to task domains (e.g., a task domain 307 and a task domain 309, respectively). As used herein, the term “task domain” can refer to a type of task that the genealogical agentic system 102 utilizes a particular task sub-graph or set of task sub-graphs to perform. For example, a task domain can correspond to, or align with, a query classification for the query 301 (or for a task extracted from the query 301) such that the classifier node 311 (and/or the routing controller 306) assign task sub-graphs based on alignment of task domains with query classifications. Example task domains (or example query classifications) include but are not limited to genealogical-relationship determination (e.g., determining a relationship between individuals based on DNA data and/or genealogical tree data), )searching for a requested genealogical content item, processing of a genealogical content item to determine individuals or other entities mentioned, date determination (e.g., determining a date of an event such as birth, marriage, or death for an individual), generating or modifying a genealogical tree (e.g., by discovering new individuals to add and creating corresponding nodes and edges), DNA analysis, facial recognition analysis,, a combination of the above, or any other suitable domain.

To illustrate by way of an example, the genealogical agentic system 102 can determine that the query 301 requests photo identification of deceased family members. The genealogical agentic system 102 can extract tasks from the query 301, including a first task to determine deceased family members for the user account and a second task to search image repositories for photos of the deceased family members. Based on query classifications for the tasks (e.g., “identify deceased family members” and “gather photos of identified individuals”), the classifier node 322 can compare the query classifications with task domains 307 and 309 (and others). Accordingly, the classifier node 322 (and/or the routing controller 306) can assign the first task to the task sub-graph 308 based on aligning the first query classification with the task domain 307. Similarly, the classifier node 322 (and/or the routing controller 306) can assign the second task to the task sub-graph 309 based on aligning the second query classification with the task domain 390.

Continuing the example, the task sub-graph 308 can include multiple nodes for executing individual operations or processes within the task sub-graph 308. For instance, the task sub-graph 308 can use a first node to call the large language model 312 for processing the first task of the query 301. In addition, the task sub-graph 308 can include a second node to call the function adapter 316. For instance, the task sub-graph 308 can call the function adapter 316 to retrieve contextual data (e.g., from a database, a RAT store, or a genealogical tree) for augmenting or informing the large language model 312 in executing the first task. In turn, the task sub-graph 308 can generate an output upon execution of the first task using the large language model 312 as guided by the function adapter 316.

Continuing the same example, the genealogical agentic system 102 can provide the output of the task sub-graph 308 to the task sub-graph 310 for executing the second task of the query 301. The task sub-graph 310 can likewise include multiple nodes for executing individual processes. Using its respective nodes, the task sub-graph 310 can thus receive the data generated by the task sub-graph 308, instantiate the function adapter 318 to retrieve data and/or perform heuristics or other functions as part of executing the second task, and implement the large language model 314 to generate the response 324 resulting from executing the first task and the second task of the query 301.

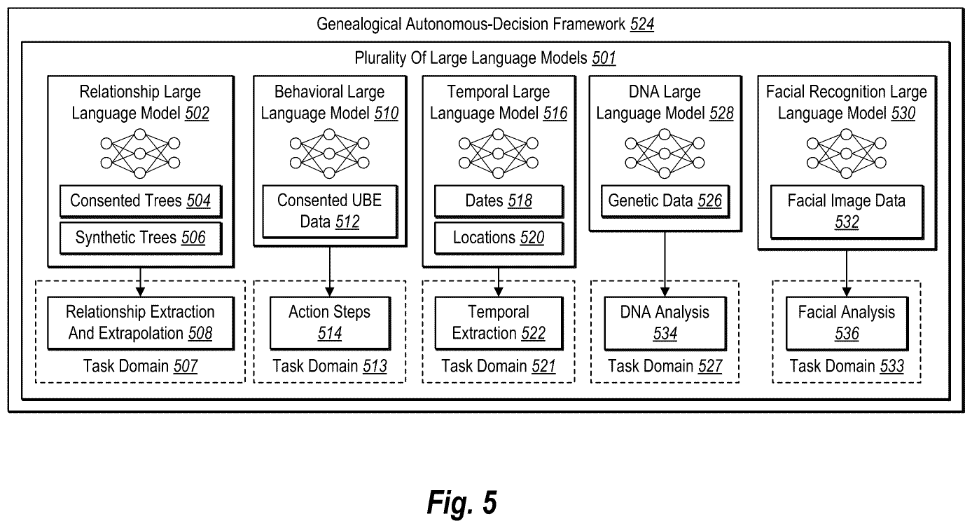

In some embodiments, the genealogical agentic system 102 can generate, train, and/or otherwise finetune the large language model 312 and/or the large language model 314. For instance, the task sub-graph 308 can call the function adapter 316 to retrieve data for fine-tuning the large language model 312. Likewise, the task sub-graph 310 can call the function adapter 318 to retrieve data for fine-tuning the large language model 314. Such retrieved data can include data specific to a query classification (or a task domain), including DNA data, genealogical tree data, RAT store items, and/or stored genealogical content items. The function adapters 316 and 318 can thus generate examples to provide to the large language models 312 and 314 from the retrieved data for fine-tuning for particular tasks. More information regarding different large language models utilized by the genealogical agentic system 102 is provided below with regard to FIG. 5.

As shown in FIG. 3, in some embodiments the genealogical agentic system 102 can generate or otherwise structure the task sub-graph 308 and the task sub-graph 310 each to include or otherwise be associated with a plurality of large language models. Indeed, each sub-graph of the genealogical autonomous-decision framework 302 include or refer to its own subsystem, complete with a set of large language models (and/or function adapters) for handling tasks in its respective task domain. The genealogical agentic system 102 can thus use the classifier node 322 (and/or the routing controller 306) to distribute tasks and orchestrate data relaying among the subsystems as part of an overall architecture for performing genealogical research workflows.

Additionally, responsive to providing the query 301 to the task sub-graph 308, the genealogical agentic system 102 can cause the large language model 312 (and/or the large language model 314) associated with the task sub-graph 308 (and/or the task sub-graph 310) to generate an instruction for a function adapter 316 (and/or a function adapter 318) to enable the function adapter 316 to generate a response 324 to the query 301 or to otherwise complete a task indicated by the query 301. For example, the instruction can indicate a location (e.g., a database, content item, or website, among others) and a task for the function adapter 318 to perform at the location.

Further, the genealogical agentic system 102 can generate the response 324 in a plurality of ways. For example, the response 324 can include a genealogical content item (e.g., a genealogical record) that includes information relating to the query 301. Additionally or alternatively, the response 324 can include an identification or addition of a tree person to a genealogical tree of a user account (e.g., a user account that provided the query 301 to the genealogical agentic system 102). In some embodiments, the genealogical agentic system 102 can determine, according to one or more privacy directives, to provide a record hint (e.g., a suggested genealogical content item) corresponding to the tree person.

As noted above, the genealogical agentic system 102 can utilize a persistence layer 320 of the genealogical autonomous-decision framework 302. The persistence layer 320 can store conversation data for query classifications as well as execution process toward a goal of the workflow (e.g., which tasks of the query 301 have been executed and which have not). The persistence layer 320 can also (or alternatively) store previous queries received by the genealogical agentic system 102, previous responses 324 generated in response to previous queries, and/or data relating to a user account (e.g., a user account that provides the query to the genealogical agentic system 102). Additionally, the persistence layer 320 can store user account preferences, session-tracking data, session-specific context, and/or navigation history. The persistence layer 320 can include short-term memory, long-term memory, one or more nodes for session-tracking, and/or one or more nodes for context retrieval.

Using the persistence layer 320, the genealogical agentic system 102 can pause and continue a genealogical research workflow at a particular task executed by an assigned task sub-graph and before completion of an entire series of tasks that make up the workflow. Using the persistence layer 320, the genealogical agentic system 102 can continue the workflow in a later session (e.g., after a user account logging off and logging in later) and/or based on starting a new workflow and later returning to the previous workflow. In some cases, the genealogical agentic system 102 can persist in memory a state of a previous genealogical research workflow based on detecting a topic change (e.g., using the classifier node 322 to determine query classifications) in a subsequent user query. The genealogical agentic system 102 can continue the previous workflow upon detecting a reversion back to the previous topic to continue the workflow by accessing the persisted state in memory (e.g., defining a most-recently executed task in the workflow and/or a next task to execute) and by executing subsequent tasks at respectively assigned task sub-graphs (or large language models).

For example, using the independent context facilitated by the persistence layer 320, a scheduler may be utilized to allow a background agent to facilitate continued research regarding a query or related node or family tree. For example, the scheduler may trigger the background agent to identify newly added historical-record collections, newly added nodes of publicly visible trees and/or corresponding clusters in a cluster database, and/or newly available genetic matches that may elucidate one or more areas of interest for a user, such as unfinished branches of a genealogical tree, nodes representing persons of interest to a user to which additional biographical details or medica can be added/attached, etc.

In some embodiments, the genealogical agentic system 102 can use the persistence layer 320 to augment the query 301. For example, the genealogical agentic system 102 can use the persistence layer to access a previously generated response to a query, a previously generated instruction for a function adapter, a previously utilized workflow, among others, to augment the query 301 and enable the genealogical agentic system 102 to generate a tailored, accurate response. While queries and query responses are described as being among the items stored in/by the persistence layer 320, it will be appreciated that this is merely exemplary, and the disclosure is not limited thereto; rather, the persistence layer 320 may be configured to retain any suitable item, datum, etc., including any user-facing or back-end functionality, data, object, or otherwise.

Additionally, the genealogical agentic system 102 can use the persistence layer 320 to accurately continue conversations and/or sessions with the user account. For example, in some embodiments, the genealogical agentic system 102 can receive the query 301 from a user account, generate the response 324, and provide the response 324 to the user account. After a passing of a period of time, the genealogical agentic system 102 can receive a second query from the user account. The genealogical agentic system 102 can determine, using the classifier node 322 and/or the routing controller 306, that the second query is a continuation of the query 301 and/or responsive to the response 324. The genealogical agentic system 102 can use the persistence layer 320 to recall information relating to the query 301 and the response 324 to enable the genealogical agentic system 102 to retrieve or otherwise recall data relating to the query 301 and/or the response 324, and thus to utilize context from the query 301 and/or response 324 to continue providing assistance to the user account rather than utilizing computational resources to repeat previously executed workflows, thereby improving the efficiency and accuracy of a genealogical agentic system 102.

In some embodiments, the genealogical agentic system 102 can autonomously determine to perform one or more additional actions to augment the query 301 (and/or to generate supplemental data for executing tasks for the query 301). For instance, using one or more of the task sub-graphs 308 or 310, the genealogical agentic system 102 can instantiate the function adapters 316 or 318 to retrieve data corresponding to the query 301, such as user account data for the requesting user account, genealogical tree data for an individual mentioned in the query 301, or a repository of genealogical content items associated with a geographical region or time period mentioned in the query 310. Using such data, the large language models 312 or 314 can generate a modified version of the query 301 that includes text mentioning the identified data (or that otherwise includes indications to retrieve the data). The genealogical agentic system 102 can thus process the modified query to generate the response 324.

In one or more embodiments, the genealogical agentic system 102 can generate the response 324 by extrapolating or interpolating additional information not expressly mentioned in the query 301. For example, the genealogical agentic system 102 can identify a new genealogical relationship (e.g., adding a tree person to a genealogical tree of a user account or identifying that a tree person pertains to the genealogical tree) as requested by the query 310. From the new genealogical relationship, the genealogical agentic system 102 can further extrapolate to determine additional genealogical relationships not explicitly indicated in the query 301. To illustrate using an example, the genealogical agentic system 102 can autonomously (e.g., without receiving an explicit instruction or request in the query 301) analyze one or more genealogical trees to identify a tree person indicated by the query 301 and to determine additional tree persons related to the tree person (e.g., within a threshold number of edges).

As another example, responsive to identifying a tree person within a genealogical tree (e.g., using task sub-graph 308), the genealogical agentic system 102 can determine to augment the genealogical tree by adding one or more “ghost nodes”, i.e. nodes corresponding to predetermined, necessary, but as-yet unpopulated genealogical relationships to a genealogical tree of the tree person (e.g., using a second task sub-graph), based on the reality that all tree persons had a mother and a father, thus even if a mother node and a father node have not been populated relative to a particular tree node, the genealogical agentic system 102 may proactively generate, e.g., a mother node and a father node relative to the tree node and populate the same with genealogical data, records, profiles, etc. as identified or determined by the genealogical agentic system 102 online or offline. Specifically, the genealogical agentic system 102 can use the ghost nodes to identify an existence of an unknown but necessary genealogical relationship in the absence of knowing specific details about the genealogical relationship. For example, the genealogical agentic system 102 can determine, responsive to identifying a tree person, that the tree person has at least two genealogical relationships (e.g., a first relationship between an individual corresponding to the tree person and a mother of the individual, and a second relationship corresponding to a father of the individual). The genealogical agentic system 102 can determine to add ghost nodes to the genealogical tree that correspond to the relationships even without a specific identity corresponding to the node. This advantageously facilitates ongoing genealogical research on behalf by the genealogical agentic system 102.

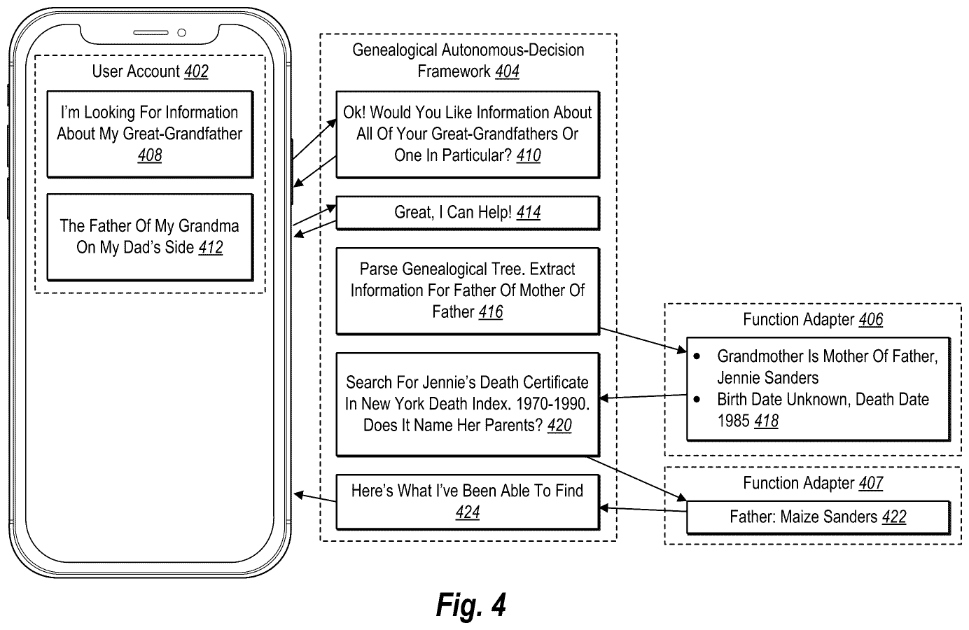

As previously mentioned, the genealogical agentic system 102 can utilize a genealogical autonomous-decision framework to generate a response to a query. FIG. 4 illustrates the genealogical agentic system 102 receiving a prompt and utilizing a genealogical autonomous-decision framework 404 (e.g., the genealogical autonomous-decision framework 302) to generate a response by orchestrating extraction of genealogical data through one or more function adapters in accordance with one or more embodiments.

As shown in FIG. 4, the genealogical agentic system 102 can receive a query 408 from a user account 402 (e.g., “I'm looking for information about my Great-Grandfather”). In some embodiments, the genealogical agentic system 102 can, based on receiving the query 408, cause a genealogical autonomous-decision framework 404 to provide a clarifying response 410 (e.g., “Ok! Would you Like Information About All of Your Great-Grandfathers Or One In Particular?”) to the user account 402. For example, the genealogical agentic system 102 can determine to utilize the clarifying response 410 to determine a scope or objective of the query 408. To illustrate, the query 408 does not clearly indicate a target individual that the user account wants more information on because it broadly states, “My Great-Grandfather.” The genealogical agentic system 102 can generate the clarifying response 410 to clarify which Great-Grandfather (e.g., of four potential great-grandfathers) and can provide the clarifying response 410 to the user account 402.

Based on providing the clarifying response 410 to the user account 402, the genealogical agentic system 102 can receive a follow-on query 412 (e.g., “The Father of My Grandma on My Dad's Side”). Responsive to receiving the follow-on query 412, the genealogical agentic system 102 can use the genealogical autonomous-decision framework 404 to generate a status update 414 (e.g., “Great! I can help!”) to provide to the user account 402 while the genealogical agentic system 102 uses the genealogical autonomous-decision framework 404 to orchestrate completion of one or more tasks indicated by the follow-on query 412 (and/or the query 408).

The genealogical agentic system 102 can utilize a classifier node of the genealogical autonomous-decision framework 404 to determine a query classification for the follow-on query 412. For example, the genealogical agentic system 102 can use the classifier node of the genealogical autonomous-decision framework 404 to detect genealogical relationships indicated by the follow-on query 412 (e.g., trigger words/phrases such as “Father,” “Grandma,” and/or “Dad's Side”) and classify the follow-on query 412 based on detecting an indication of genealogical relationships. Accordingly, the genealogical agentic system 102 can use a routing controller of the genealogical autonomous-decision framework 404 to provide the follow-on query 412 to a pertinent task sub-graph according to the query classification.

As shown in FIG. 4, the genealogical agentic system 102 can use the genealogical autonomous-decision framework to generate an instruction 416 (e.g., “Parse Genealogical Tree. Extract Information For Father of Mother of Father”). Specifically, the genealogical agentic system 102 can use a large language model associated with the pertinent task sub-graph of the genealogical autonomous-decision framework 404 to generate the instruction 416. In some cases, the instruction 416 is executable computer code in a language and format interpretable and executable by the function adapter 406, where the computer code defines functions for parsing the genealogical tree and extracting information for the father of the mother of the father.

In some embodiments, the genealogical agentic system 102 can provide the follow-on query 412 to a pertinent task sub-graph associated with a large language model specifically trained or otherwise fine-tuned on data corresponding to the query classification (e.g., relationship data). Accordingly, the genealogical agentic system 102 can use the relationship-data large language model to generate the instruction 416 enabling the function adapter 406 to fulfil or otherwise complete functions indicated by the instruction 416. For example, the genealogical agentic system 102 can use the relationship-data large language model to generate the instruction 416 to indicate a particular genealogical path and a particular destination (e.g., a series of tree nodes of a genealogical tree and edges connecting the tree nodes) of a genealogical tree.

As illustrated in FIG. 4, the genealogical agentic system 102 can use the function adapter 406 to generate a response 418 (e.g., “Grandmother is Mother of Father, Jennie Sanders;” and “Birth Date Unknown, Death Date 1985”) to the instruction 416 (e.g., a response to the follow-on query 412). In some embodiments, the genealogical agentic system 102 can determine that the response 418 to the instruction 416 does not contain a response to the follow-on query 412. For example, the genealogical agentic system 102 can determine that the follow-on query 412 requested information about a great-grandfather of a user relating to the user account 402, but that the response 418 to the instruction 416 does not contain any genealogical information pertaining to the specified great-grandfather. Based on determining that the response 418 to the instruction 416 does not contain genealogical information relating to the follow-on query 412, the genealogical agentic system 102 can use the genealogical autonomous-decision framework 404 to generate a second instruction 420 (e.g., “Search For Jennie's Death Certificate in New York Death Index. 1970-1990. Does It Name Her Parents?”) for a second function adapter 407.

To elaborate, responsive to determining that the function adapter 406 did not generate or otherwise extract genealogical data corresponding or fully responsive to the follow-on query 412, the genealogical agentic system 102 can determine to utilize a different approach and/or a different function adapter (e.g., the second function adapter 407). For example, the genealogical agentic system 102 can determine that a genealogical database corresponding to the function adapter 406 does not contain genealogical data corresponding to the follow-on query 412 or that the function adapter 406 is otherwise unable to fully determine the requested information. Responsive to determining that an attempt by the function adapter 406 to extract genealogical data corresponding to the follow-on query 412 was unsuccessful, the genealogical agentic system 102 can determine to utilize the second function adapter 407 which retrieves data from other sources and which can fully determine the requested information. For example, the genealogical agentic system 102 can determine to extract genealogical data from a website or online repository, and can generate the second instruction 420 identifying the online repository (e.g., “New York Death Index. 1970-1990”) and instructing the second function adapter 407 to search the identified online repository.

Additionally, as illustrated in FIG. 4, the genealogical agentic system 102 can utilize information from the response 418 to the instruction 416 to generate the second instruction 420. For example, the response 418 to the instruction 416 provided genealogical information related to the follow-on query 412 by identifying the “Grandma” indicated in the follow-on query 412 by providing a name and death date for the Grandma. Moreover, based on the response 418 to the instruction 416, the genealogical agentic system 102 can determine to use a second task sub-graph of the genealogical autonomous-decision framework 404.

For example, the genealogical agentic system 102 can use the classifier node of the genealogical autonomous-decision framework 404 to determine a classification for the response 418 (e.g., a query classification as if the response 418 was a query). Based on determining the classification, the genealogical agentic system 102 can use the routing controller of the genealogical autonomous-decision framework 404 to provide the response 418 to a second task sub-graph corresponding to a second large language model. The genealogical agentic system 102 can use the second large language model (e.g., a large language model trained or otherwise fine-tuned utilizing temporal data rather than genealogical data) to generate the second instruction 420. In this manner, the genealogical agentic system 102 can iteratively utilize different task sub-graphs to interface with different function adapters 406, 407 to generate or otherwise extract genealogical data relating to the query 412.

As shown in FIG. 4, the genealogical agentic system 102 can use the genealogical autonomous-decision framework 404 to provide the second instruction 420 to a second function adapter 407. Based on providing the second instruction 420 to the second function adapter 407, the genealogical agentic system 102 can cause the second function adapter 407 to generate, determine, or otherwise extract genealogical data 422 (e.g., “Father: Maize Sanders”) corresponding to the query 412. Further, based on determining the genealogical data 422, the genealogical agentic system 102 can generate a response 424 (e.g., “Here's What I've Been Able To Find . . . ”) to the query 412. The genealogical agentic system 102 can utilize a large language model of the genealogical autonomous-decision framework 404 to generate the response based on the determined genealogical data 422 and/or the follow-on query 412.

As illustrated by the previous discussion, in some embodiments, the genealogical agentic system 102 can parse the query 408 (and/or the follow-on query 412) to determine a plurality of tasks from the query 408 and/or follow-on query 412. In some embodiments, the plurality of tasks can correspond to different task domains. In some embodiments, the plurality of tasks can correspond to iteratively, serially, and/or in parallel utilizing different task sub-graphs to extract or otherwise identify genealogical data corresponding to the query 408 and/or the follow-on query 412 (e.g., the instruction 416 can correspond to a first task of the plurality of tasks and the second instruction 420 can correspond to a second task of the plurality of tasks).

Moreover, in instances where the genealogical agentic system 102 implements multiple task sub-graphs, corresponding large language models, and/or function adapters 406, 407 to extract genealogical data 422 corresponding to the follow-on query 412 (e.g., in instances where the genealogical agentic system 102 iteratively called a plurality of tools to determine the genealogical data 422), the genealogical agentic system 102 can utilize a large language model corresponding to the routing controller to aggregate responses generated by different function adapters (e.g., the function adapter 406 and the second function adapter 407). For example, the genealogical agentic system 102 can generate the response 424 to the follow-on query 412 to include the genealogical data 422 as well as the response 418 to the instruction. Further, the genealogical agentic system 102 can provide the response 424 to the user account 402 (e.g., for display on the client device).

As previously mentioned, the genealogical agentic system 102 can train or otherwise fine-tune a plurality of large language models. FIG. 5 shows the genealogical agentic system 102 generating a plurality of large language models utilizing different data sets in accordance with one or more embodiments. While FIG. 5 illustrates example large language models, the genealogical autonomous-decision framework 524 can include more or fewer large language models for nodes of various types or classifications.

As shown in FIG. 5, the genealogical agentic system 102 can fine-tune and utilize a plurality of large language models 501 within a genealogical autonomous-decision framework 524 (e.g., where each large language model corresponds to, or is part of, a respective sub-graph). For example, the plurality of large language models 501 can include (among others) a relationship large language model 502, a behavioral large language model 510, a temporal large language model 516, a DNA large language model 528, and a facial recognition large language model 530, among others. The genealogical agentic system 102 can use specialized examples, including sample user queries and corresponding responses (or code segments for executed tasks corresponding to user queries), to fine-tune the respective large language models. For instance, the genealogical agentic system 102 can fine-tune large language models using function adapters to retrieve data specific to a task domain (or a user classification) for fine-tuning examples.

As illustrated in FIG. 5, the genealogical agentic system 102 can train or otherwise generate the relationship large language model 502 with consented trees 504 and/or synthetic trees 506. The consented trees 504 can be genealogical trees corresponding to user accounts where the user accounts have given consent for the genealogical agentic system 102 and/or a genealogical data system (e.g., a genealogical data system 1302 discussed below with regard to FIG. 13) to utilize the consented trees 504 to train and/or fine tune the relationship large language model 502.

For example, the genealogical agentic system 102 can train or fine-tune the relationship large language model 502 to understand vocabulary relating to genealogical relationships and how that vocabulary maps to constructs such as genealogical trees. To illustrate, the genealogical agentic system 102 can use the consented trees 504 and/or the synthetic trees 506 to train and/or fine-tune the relationship large language model 502 to perform relationship extraction and extrapolation 508. Relationship extraction and extrapolation 508 can include tasks such as parsing a genealogical tree to determine a genealogical relationship between two nodes and generating an accurate description of the relationship. Further, relationship extraction and extrapolation 508 can include inferring or otherwise extrapolating a new genealogical relationship within a genealogical tree based on one or more genealogical relationships that currently exist in one or more genealogical trees. Relationship extraction and extrapolation 508 can further include inferring genealogical relationships based on a comparison of a tree node and a genealogical tree, a comparison of two different genealogical trees, a comparison of a record and a node, a comparison of a record and a genealogical tree, a comparison of two records, a comparison of two nodes, a comparison of three or more of the any of the aforementioned items, etc. Relationship extraction and extrapolation 508 can be a task domain 507.

Additionally, as illustrated in FIG. 5, the genealogical agentic system 102 can train and/or fine-tune a behavioral large language model 510 using consented UBE data 512. Specifically, the consented UBE data 512 can be User Behavior Data/User Behavioral Embeddings from user accounts within the genealogical agentic system 102 and/or a genealogical data system (e.g., the genealogical data system 1302 of FIG. 13) that user accounts have indicated or otherwise given permission for the genealogical agentic system 102/genealogical data system to use. For example, the consented UBE data 512 can include clickstream data (e.g., website navigation, button clicks, page views, etc.), search history (e.g., queries, query frequency, refinements to queries), engagement metrics (e.g., time spent on pages, video watch time, scrolling behavior, etc.), application interactions (e.g., feature usage, session length, etc.), device and platform data (e.g., device type, screen resolution & UI preferences, battery & connectivity status, etc.), among others.

As illustrated in FIG. 5, the genealogical agentic system 102 can train the behavioral large language model 510 to perform action steps 514. For example, the action steps 514 can be patterns, workflows, or other processes the genealogical agentic system 102 uses the genealogical autonomous-decision framework 524 to implement. To illustrate, the action steps 514 can be a problem-solving approach implemented by a router node of the genealogical autonomous-decision framework 524 to generate a response to a query (e.g., the genealogical agentic system 102 can utilize the behavioral large language model 510 to augment the routing controller of the genealogical autonomous-decision framework 524). The action steps 514 can involve using or instantiating different task sub-graphs and corresponding function adapters to generate a response to a query. Indeed, the action steps 514 can be focused on a task domain 513 (or query classification) relating to a particular data type of data or function performed by the behavioral large language model 510.

As shown in FIG. 5, the genealogical agentic system 102 can train and/or fine-tune the temporal large language model 516 using dates 518 and locations 520 to enable the temporal large language model 516 to perform temporal extraction 522. Additionally, temporal extraction 522 can be a task domain 521. For example, the genealogical agentic system 102 can train or otherwise fine-tune the temporal large language model 516 to accurately extract or otherwise track times and dates related to queries and/or individuals in genealogical trees (e.g., tree nodes). Further, the genealogical agentic system 102 can use the temporal large language model 516 to perform temporal extraction in conjunction with using the relationship large language model 502 to perform relationship extraction and extrapolation 508.

Further, the genealogical agentic system 102 can train, fine-tune, or otherwise generate the DNA large language model 528 utilizing genetic data 526. For example, the genetic data 526 can include genomic databases and genetic reference panels, population genetics and historical migration studies, relationship and kinship analysis data, among others. Further, based on training or otherwise finetuning the DNA large language model 528 with the genetic data 526, the genealogical agentic system 102 can use the DNA large language model 528 to perform tasks relating to a task domain 527, such as DNA analysis 534 or DNA matching. For example, the genealogical agentic system 102 can perform DNA analysis 534 tasks within the task domain 527 such as admixture analysis, principal component analysis, pedigree reconstruction, migration pathways reconstruction, chromosome and segment analysis, autosomal DNA segment clustering, phasing of genotypes into haplotypes, imputation of SNPs, among others.

Further, as illustrated, the genealogical agentic system 102 can train, generate, or otherwise fine-tune a facial recognition large language model 530 using facial image data 532. The facial image data 532 can be a plurality of facial image datasets such as a historical figures face dataset, national archives and records administration (NARA) images, black-and-white to colorization datasets, family faces datasets, kinship recognition datasets (e.g., families in the wild datasets), among others. Further, based on training or otherwise finetuning the facial recognition large language model 530 with the facial image data 532, the genealogical agentic system 102 can use the facial recognition large language model 530 to perform tasks within a task domain 533, such as facial analysis 536. For example, the genealogical agentic system 102 can perform facial analysis 536 tasks within the task domain 533 such as facial identification and matching, kinship recognition, face aging and reconstruction, facial feature classification and tagging, facial verification for historical research, among others.

While certain large language models have been described, it will be appreciated that the disclosure is not limited thereto; rather, any suitable number of large language models performing any suitable functions may be utilized by the genealogical autonomous-decision framework 524. Such functions may include, match prediction, community and/or ethnicity assignment prediction, trait prediction, or otherwise), record-content extraction, hint generation, or any other suitable function.

Additionally, as shown in FIG. 5, the genealogical agentic system 102 can use the genealogical autonomous-decision framework 524 to select one or more large language models from among the plurality of large language models 501 according to a query classification and/or one or more task domains of tasks within the query. Indeed, the genealogical agentic system 102 can generate and assign a series of tasks to respective large language models within a single flow for an overall genealogical research workflow, where the workflow includes one or more queries from which tasks are extracted, classified, and assigned.

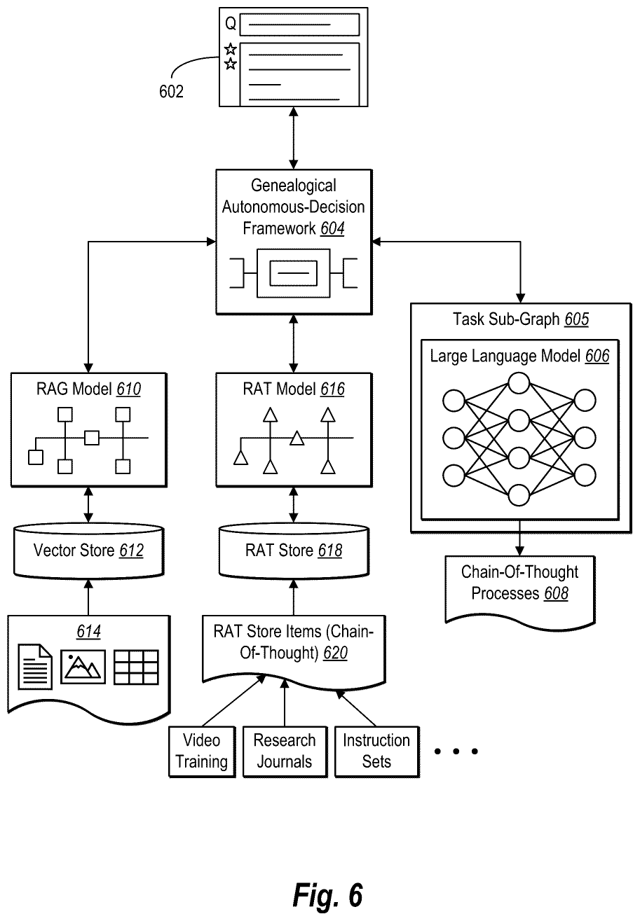

As mentioned above, the genealogical agentic system 102 can utilize a retrieval-augmentation approach to generating responses for queries. In particular, the genealogical agentic system 102 can inform a genealogical autonomous-decision framework 524 and/or specific genealogical large language models for performing tasks using a retrieval-augmented generation (RAG) approach and/or using a one-shot approach from retrieval-augmented thought (RAT) store items. FIG. 6 illustrates an example overview of the genealogical agentic system 102 utilizing RAG and/or RAT to generate a response to a query in accordance with one or more embodiments.

As noted above, the genealogical agentic system 102 can utilize RAG or RAT approaches to augment or inform large language models at a variety of stages or components of a genealogical autonomous-decision framework 604. For instance, the genealogical agentic system 102 can fine-tune or modify a large language model of a classifier node using RAT store items and/or RAG data. As another example, the genealogical agentic system 102 can fine-tune or modify a large language model specific to a task sub-graph using RAT store items and/or RAG data.

Regarding RAT, in some embodiments, the genealogical agentic system 102 determines that a particular agentic model, such as a task sub-graph 605 or a large language model 606, cannot (with a threshold degree of confidence or accuracy) generate a response to a received prompt based on its already learned parameters. Based on such a determination, the genealogical agentic system 102 can search a repository of RAT store items 620 that include text descriptions of instructions, processes, and/or step-by-step functions executable to perform a particular task, where the instructions are interpretable by the large language model 606 to inform or augment its chain of thought (e.g., its internal parameters). For instance, the RAT store items 620 can include expert-generated instruction sets and/or examples of generated responses specific or applicable to the received prompt.

The genealogical agentic system 102 can thus analyze the RAT store items 620 using the large language model 606 to identify one or more of the RAT store items 620 that correspond to the prompt. In some embodiments, the genealogical agentic system 102 further utilizes the large language model 606 to execute processes defined by the text descriptions in an identified RAT store item 620 (e.g., by executing processes indicated by text descriptions of processes in an instruction set or by generating a response matching a provided example corresponding to the prompt). Through this process, the genealogical agentic system 102 uses a one-shot approach to informing the large language model 606 for generating responses to prompts that the large language model 606 could not previously process. Upon (or as part of) informing the large language model 606 to perform the new processes indicated by the text descriptions of an identified RAT store item 620 pertinent to the query, the genealogical agentic system 102 can further perform additional processes, such as accessing additional content items to generate a response for the prompt (e.g., in a retrieval-augmented generation or RAG approach).

As illustrated in FIG. 6, the genealogical agentic system 102 can utilize a genealogical autonomous-decision framework 604 to receive a query from a user interface 602 and generate a response to the query and provide the response in the user interface 602. Indeed, as previously discussed, the genealogical agentic system 102 can utilize a large language model 606 of a task sub-graph 605 to generate a response to the query. In some cases, the genealogical agentic system 102 can inform the large language model 606 to generate the response using RAG and/or RAT. For instance, the large language model 606 executes or generates one or more chain of thought processes 608 that include processes or functions executed in a sequence to generate the response. Indeed, the genealogical agentic system 102 can utilize a RAG model 610 and/or a RAT model 616 to inform or augment various components of the genealogical autonomous-decision framework 604, including nodes or large language models performing particular tasks, a classifier node for classifying user queries, and/or other components.

As illustrated in FIG. 6, in some embodiments, the genealogical agentic system 102 can generate a response to a query utilizing the RAG model 610. Specifically, the genealogical agentic system 102 can use the RAG model 610 to access a vector store 612 for analyzing stored vectors of content items 614. Further, the genealogical agentic system 102 extracts, for example using an embedding model, vector embeddings from the content items 614 to store in the vector store 612. As an example of a generated response, the genealogical agentic system 102 can generate or surface genealogical content items, such as record hints or individual names for adding to a genealogical tree and/or database, responsive to the query. Thus in response to, e.g., the follow-on query 412 “The Father of my Grandma on my Dad's Side,” content items 614 include historical records, such as Census records, that include the specified paternal great-grandfather, may be identified from a vector search of the vector store 612, with the identified content items 614 retrieved and surfaced, in embodiments, as part of the response.

That is, the genealogical agentic system 102 can further compare the vectors in the vector store 612 with a vector the genealogical agentic system 102 extracts from a query provided via the user interface 202 to identify one or more content items 614 to use as sources to inform the large language model 606 in generating or utilizing chain-of-thought processes for a response. Additionally, the genealogical agentic system 102 can determine an accuracy score for a response (or for a chain-of thought process) generated using the RAG model 610. For example, the genealogical agentic system 102 can determine the accuracy score based on a confidence level or a closeness of retrieved RAG data (e.g., from the vector store 612) to a query vector (or a task vector) in vector space. The genealogical agentic system 102 can determine to proceed to use the RAT model 616 if the accuracy score for the response fails (based on the RAG data) to satisfy a threshold measure of accuracy. Further, in some embodiments, the genealogical agentic system 102 can determine to bypass using the RAG model 610 and immediately proceed to generate a response using the RAT model 616.

As illustrated in FIG. 6, in some embodiments, the genealogical agentic system 102 can utilize the RAT model 616 to access a RAT store 618 for analyzing stored vectors of RAT store items 620. The genealogical agentic system 102 can determine an accuracy score for a response generated using the RAT model 616 and can determine to use the RAG model 610 if an accuracy score for the response fails to satisfy a threshold measure of accuracy.

As shown in FIG. 6, the genealogical agentic system 102 can generate a response using the RAT model 616 by generating or otherwise identifying RAT store items 620. To illustrate, the genealogical agentic system 102 can generate the RAT store items 620 from expert-generated content items such as training videos, research journals, and/or curated instruction sets for various chains of thought. The genealogical agentic system 102 can further use an embedding model to extract RAT embeddings from the RAT store items 620 to store in the RAT store 618. Additionally, the genealogical agentic system 102 can compare the RAT embeddings in the RAT store 618 with a query embedding to identify one or more relevant RAT embeddings corresponding to relevant RAT store 618 items for informing chain-of-thought response generation through the large language model 606. As part of generating a response informed by a RAT store 618 item, the genealogical agentic system 102 can use the genealogical autonomous-decision framework 604 to perform RAG-based steps (as instructed by the RAT store item) to access and extract data from relevant content items for generating a response.

Additionally, the genealogical agentic system 102 can determine to use the RAT model 616 and/or the RAG model 610 in any of various processes conducted through the genealogical autonomous-decision framework 604. For example, the genealogical agentic system 102 can determine to use the RAT model 616 (and/or the RAG model 610) to determine a query classification for a query received through the user interface 602 (e.g., the genealogical agentic system 102 can use a RAT store 618 item to inform a chain-of-thought process the genealogical agentic system 102 uses to classify a query). Additionally, the genealogical agentic system 102 can determine to use the RAT model 616 (and/or the RAG model 610) to execute a task (and/or generate a response) at a task sub-graph within the genealogical autonomous-decision framework 604. For instance, the genealogical agentic system 102 can use a RAT store 618 item to determine that a ghost node exists in a genealogical tree of a user account (or that the tree is missing a node), to determine DNA information about an individual in a genealogical tree, to identify genealogical records about a requested individual, and/or to determine other information for a requested individual (or for a requested timeframe or a requested record).

Moreover, the genealogical agentic system 102 can use the RAT model 616 (and/or the RAG model 610) to identify one or more tasks from a query and determine respective query classifications for the tasks (e.g., the genealogical agentic system 102 can use a RAT store 618 item to inform a chain-of-thought the genealogical agentic system 102 uses to parse a query to determine one or more tasks from the query and the genealogical agentic system 102 can use a second RAT store 618 item to inform a second chain-of-thought the genealogical agentic system 102 uses to determine corresponding task sub-graphs to provide the one or more tasks to). Additionally, the genealogical agentic system 102 can use the RAT model 616 (and/or the RAG model 610) to determine a function adapter for a task sub-graph to send an instruction to (e.g., the genealogical agentic system 102 can use a RAT store item to inform a chain-of-thought the genealogical agentic system 102 uses to identify a function adapter to perform a task or generate/extract genealogical data in response to a query).

More information regarding using a RAG model or a RAT model to generate a response to a query can be found in U.S. Provisional Application No. 63/688,580, titled RETRIEVAL AUGMENTED THOUGHT FOR AGENTIC MODELS, filed on Aug. 29, 2024. The aforementioned application is hereby incorporated by reference in its entirety.

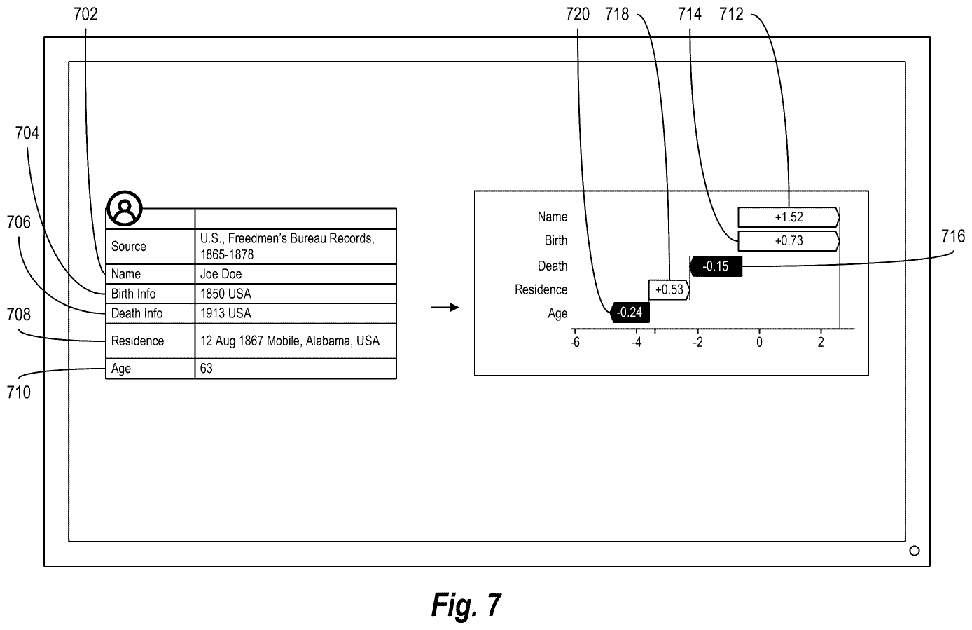

As previously mentioned, the genealogical agentic system 102 can extract a plurality of attributes of a tree person. FIG. 7 illustrates the genealogical agentic system 102 extracting the plurality of tree attributes and determining a plurality of impactfulness scores for the tree attributes in accordance with one or more embodiments.

As shown in FIG. 7, the genealogical agentic system 102 can extract or otherwise determine a plurality of attributes 702-710 for a tree person. For example, the genealogical agentic system 102 can identify the tree person within a genealogical tree responsive to receiving a query and implementing one or more workflows to generate a response to the query. To illustrate, the genealogical agentic system 102 can receive a query asking the genealogical agentic system 102 to identify an ancestor (e.g., a family member of a user corresponding to a user account). Responsive to receiving the query, the genealogical agentic system 102 can identify a tree person in a genealogical tree as a possible match. To confirm that the tree person corresponds to the ancestor, the genealogical agentic system 102 can extract the plurality of attributes 702-710 from the tree person and determine a plurality of impactfulness scores 712-720 for the plurality of attributes.

As illustrated in FIG. 7, the genealogical agentic system 102 can extract the plurality of attributes 702-710 by extracting a first attribute 702 corresponding to a name (for example a first name and a surname, such as “Joe Doe”) for the tree person. Additionally, the genealogical agentic system 102 can extract a second attribute 704 corresponding to birth information for the tree person (e.g., “1850 USA”). Moreover, the genealogical agentic system 102 can extract a third attribute 706 corresponding to death information for the tree person (e.g., 1913 USA). Further, the genealogical agentic system 102 can determine a fourth attribute 708 corresponding to a residence of the tree person (e.g., “12 Aug 1867 Mobile, Alabama, USA”). In addition, the genealogical agentic system 102 can extract a fifth attribute 710 corresponding to an age for the tree person (e.g., “63”).

In some embodiments, the genealogical agentic system 102 can determine or otherwise extract additional attributes for the tree person, such as known genealogical relationships, additional known residences, migrations between residences, other names associated with the tree person, one or more professions associated with the tree person, one or more religions associated with the tree person, a race associated with the tree person, among others. Additionally, the genealogical agentic system 102 can extract attributes for the tree person from one or more sources (e.g., a website, a genealogical database, a genealogical tree, among others).

Responsive to extracting the plurality of attributes 702-710 for the tree person, the genealogical agentic system 102 can determine the plurality of impactfulness scores 712-720 for the plurality of attributes 702-710. In some embodiments, the genealogical agentic system 102 can determine the plurality of impactfulness scores 712-720 by determining a Shapley value for each attribute (e.g., the plurality of impactfulness scores 712-720 can be Shapley values). Specifically, the genealogical agentic system 102 can use an algorithm or machine learning model to determine the Shapley values for each attribute of the plurality of attributes. To illustrate, the genealogical agentic system 102 can generate or otherwise determine the Shapley values to indicate a relative level of importance of an attribute of the plurality of attributes in confirming that the tree person corresponds to the individual. For example, the genealogical agentic system 102 can determine a Shapley value 712 corresponding to the first attribute 702, a Shapley value 714 corresponding to the second attribute 704, a Shapley value 716 corresponding to the third attribute 706, a Shapley value 718 corresponding to the fourth attribute 708, and a Shapley value 720 corresponding to the fifth attribute 710.

Moreover, responsive to determining that one or more of the plurality of impactfulness scores are above a threshold, the genealogical agentic system 102 can generate a response to the query indicating a relationship (e.g., a genealogical relationship) between an individual corresponding to the tree person and a user corresponding to a user account of a client device (e.g., a user account that the genealogical agentic system 102 receives the query from).

Additionally, the genealogical agentic system 102 can determine the threshold on a case by case basis. To illustrate, the genealogical agentic system 102 can assign weights to the plurality of attributes and/or the plurality of impactfulness scores to indicate a relative level of importance of each of the plurality of attributes. For example, in some instances, the genealogical agentic system 102 can determine that a first attribute, such as a birth date, is relatively more important or consequential than a second attribute, such as a name. Conversely, in some instances, the genealogical agentic system 102 can determine that a third attribute, such as a residence, is more important than a fourth attribute, such as an age.

Additionally, in some embodiments, the genealogical agentic system 102 can identify a first tree person and a second tree person as a part of generating a response to a query. The genealogical agentic system 102 can extract a first plurality of attributes corresponding to the first tree person and a second plurality of attributes corresponding to the second tree person. Further, the genealogical agentic system 102 can determine a first set of impactfulness scores and/or a first set of Shapley values corresponding to the first set of attributes, and a second set of impactfulness scores and/or a second set of Shapley values corresponding to the second set of attributes. Based on determining the first set of impactfulness scores and the second set of impactfulness scores, the genealogical agentic system 102 can compare the first set of impactfulness scores and the second set of impactfulness scores to determine one or more impactfulness score differentials between the first set of impactfulness scores and the second set of impactfulness scores. The genealogical agentic system 102 can use the one or more impactfulness score differentials to determine which tree person (e.g., between the first tree person and the second tree person) corresponds to the individual.

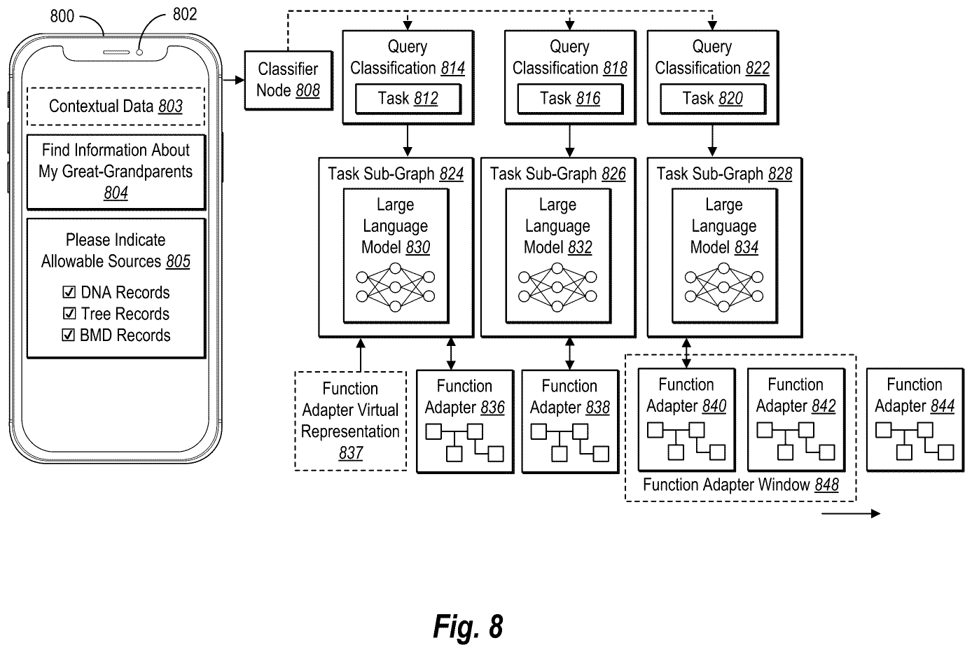

As previously mentioned, in some embodiments the genealogical agentic system 102 can iteratively determine a plurality of tasks from a query to generate a response to a query (e.g., the genealogical agentic system 102 can instantiate one or more workflows in a piecewise manner to extract genealogical data in response to a query). Additionally, in some embodiments, the genealogical agentic system 102 can parse a query to determine a plurality of tasks implicitly stated in the query. FIG. 8 illustrates the genealogical agentic system 102 parsing a query in accordance with one or embodiments. In some cases, parsing a query involves determining a plurality of tasks from the query, determining respective query classifications for the plurality of tasks, determining an order of completion for the plurality of tasks, and/or providing the plurality of tasks to corresponding task sub-graphs according to the respective query classifications.

As shown in FIG. 8, the genealogical agentic system 102 can receive a query 804 (e.g., “Find Information About My Great-Grandparents”) through a user interface 802 of a client device 800. In some embodiments, as part of receiving the query 804, the genealogical agentic system 102 can generate a notification 805 to indicate allowable/permitted data sources (e.g., such as DNA records or data, genealogical tree records and/or data, birth/marriage/death (BMD) records and/or data) for the genealogical agentic system 102 to utilize to generate the response. Indeed, the genealogical agentic system 102 can determine, using a classifier node 808, one or more task sub-graphs 824, 826, 828 and their corresponding data types for generating a response. The genealogical agentic system 102 can thus populate the notification 805 with selectable elements for the data types or classifications corresponding to the classifications of the task sub-graphs 824, 826, 828 for the query 804. Upon receiving selections of allowed/permitted sources via the notification 805, the genealogical agentic system 102 can use the task sub-graphs 824, 826, 828 824, 826, 828 (and their respective large language models 830, 832, 834) to execute tasks and/or generate a response. In some cases, the genealogical agentic system 102 utilizes the function adapters 836, 838, 840 to access the data of the identified data types for informing the large language models 830, 832, 834 and/or for executing processes based on the data types.

Responsive to receiving the query 804, the genealogical agentic system 102 can parse the query 804 (e.g., utilizing a routing controller and/or a classifier node of a genealogical autonomous-decision framework) to determine a plurality of tasks (e.g., a task 812, a task 816, and a task 820) implicitly stated in or required by the query 804. For example, the genealogical agentic system 102 can determine from the query 804, the task 812 of identifying or otherwise extracting existing nodes within a genealogical tree of a user account (e.g., the user account that submitted the query 804). Further, the genealogical agentic system 102 can determine from the query 804, the task of 816 of identifying or otherwise extracting information (e.g., genealogical content items) relating to missing nodes within or pertaining to the genealogical tree. In addition, the genealogical agentic system 102 can determine from the query 804, the task 820 of identifying or otherwise extracting genetic information relating to the missing nodes within or pertaining to the genealogical tree.

Further, the genealogical agentic system 102 can utilize the classifier node 808 of the genealogical autonomous-decision framework to determine respective query classifications for the plurality of tasks (e.g., a query classification 814 corresponding to the task 812, a query classification 818 corresponding to the task 816, and a query classification 822 corresponding to the task 820). For example, the query classification 814 can be “identifying genealogical content items.” Additionally, the query classification 822 can be “identifying genetic information.” Further, in some embodiments, the genealogical agentic system 102 can determine the respective query classifications 814, 818, and 822 according to contextual data 803 (e.g., contextual genealogical data) associated with a user account of the client device 800. For example, the genealogical agentic system 102 can extract the contextual data 803 by extracting metadata, query history, known genealogical tree data, and/or device-specific data, among others. For example, the genealogical agentic system 102 can extract and use the contextual data 803 to determine known genealogical relationships from a genealogical tree of the user account (and/or a genealogy maintained by the genealogy data system 106) and determine or otherwise augment the query classification 822 (e.g., “identifying genetic information”) according to the contextual data 803.

Responsive to determining the respective query classifications for the plurality of tasks (e.g., the query classification 814 for the task 812, the query classification 818 for the task 816, and the query classification 822 for the task 820), the genealogical agentic system 102 can provide the plurality of tasks to task sub-graphs 824, 826, 828 corresponding to the respective query classifications. For example, the genealogical agentic system 102 can provide the task 812 to a task sub-graph 824 according to the query classification 814, the task 816 to a task sub-graph 826 according to the query classification 818, and the task 820 to a task sub-graph 828 according to the query classification 822.

In one or more embodiments, the genealogical agentic system 102 determines an order of completion or an order of execution for the tasks 812, 816, and 820. As part of determining an order of completion, the genealogical agentic system 102 determines execution data for each task. To determine execution data for the task 812, the genealogical agentic system 102 determines data (e.g., from among the contextual data 803 and/or other data sources) that the task sub-graph 824 requires to implement the large language model 830. In some cases, the execution data includes specific function parameters indicated by computer code of the function adapter 836 and/or information indicated by the large language model 830 as necessary to execute the task 812.

If the genealogical agentic system 102 determines execution data for the task 812 that is part of or relies on a result of (e.g., output generated by execution of) another task, such as the task 816, then the genealogical agentic system 102 determines that the task 816 is executed before the task 812. The genealogical agentic system 102 can thus use data generated by execution of the task 816 (e.g., via the task sub-graph 826 implementing the large language model 832 and/or the function adapter 838) as input for the sub-graph 824 in executing the task 812. The genealogical agentic system 102 can thus determine data dependencies among the tasks 812, 816, and 820 to determine which tasks depend on data generated through execution of which other tasks. Such data dependencies inform the genealogical agentic system 102 in determining the order of completion for the tasks 812, 816, 820.

In some cases, the genealogical agentic system 102 executes multiple tasks in parallel (e.g., simultaneously with one another). For instance, the genealogical agentic system 102 determines that task 820 has no data dependency with task 812. Accordingly, the genealogical agentic system 102 determines that task 820 and task 812 are executable in parallel. The genealogical agentic system 102 can thus parallelly apply or implement the task sub-graph 824 and the task sub-graph 828 to execute their respective tasks.

In some embodiments, such as when the genealogical agentic system 102 parses the query 804 to determine the plurality of tasks (e.g., the task 812, the task 816, and the task 820), the genealogical agentic system 102 can generate query segments corresponding to the plurality of tasks and provide each of the query segments to a corresponding task sub-graph. For example, the genealogical agentic system 102 can provide the task 812 and a query segment corresponding to the task 812 to the task sub-graph 824. Similarly, the genealogical agentic system 102 can provide the task 816 and a query segment corresponding to the task 816 to the task sub-graph 826. Further, the genealogical agentic system 102 can provide the task 820 and a query segment corresponding to the task 820 to the task sub-graph 828.

By generating and providing query segments to corresponding task sub-graphs, the genealogical agentic system 102 can encapsulate and expose certain aspects of the query 804 (and/or of a conversation with a user account comprising multiple queries) to different task sub-graphs, leaving other sub-graphs unexposed to other data or other portions of the query 804 (or queries of the conversation). Indeed, the genealogical agentic system 102 can encapsulate the task sub-graph 824, the task sub-graph 826, and the task sub-graph 828, to maintain separate privacy states among the plurality of task sub-graphs (e.g., the task sub-graph 824, the task sub-graph 826, and the task sub-graph 828). Further, by providing query segments to corresponding task sub-graphs of the plurality of task sub-graphs (e.g., e.g., the task sub-graph 824, the task sub-graph 826, and the task sub-graph 828), the genealogical agentic system 102 can reduce the amount of data to be tokenized by each task sub-graph of the plurality of task sub-graphs, thus reducing the computational resources the genealogical agentic system 102 uses to generate a response to the query 804.

As shown in FIG. 8, the genealogical agentic system 102 can identify a plurality of function adapters (e.g., the function adapter 836, the function adapter 838, and the function adapter 840) based on providing the plurality of tasks 812, 816, 820 to the corresponding task sub-graphs 824, 826, 828. Further, the genealogical agentic system 102 can use a large language model of each of the corresponding task sub-graphs 824, 826, 828 (e.g., the large language model 830, the large language model 832, and the large language model 834) to generate a plurality of instructions for the plurality of function adapters 836, 838, 840.

In some embodiments, one or more of the plurality of function adapters 836, 838, 840 can perform one or more functionalities of a geographical information system, such as geospatial mapping (e.g., naming or otherwise identifying geographic-based features at a specific point in time such as county boundaries, state boundaries, political boundaries, boundaries of utilities such as water, electricity, and/or transit boundaries, etc.), geofencing and zone-based automation (e.g., automatically applying one or more data processing policies according to one or more geographical requirements), genealogical tree management (including, e.g., adding or updating nodes to existing genealogical trees, generating new trees based on DNA matches, genealogical records, existing trees, etc., populating genealogical trees with ghost nodes facilitating offline research thereregarding, etc.), cluster-database management (including, e.g., resolving nodes in distinct genealogical trees that represent a same person to a cluster of a cluster database; updating clusters based on determined likelihood of consanguinity; generating hints for users based on clusters and associated data, records, and media; etc.), DNA management (including, e.g., phasing of genotypes into haplotypes or imputation of SNPs, match prediction, community and/or ethnicity assignment prediction, trait prediction, identification of a most-recent common ancestor, relationship classification, de novo tree-building from DNA data, etc.), historical-record management (including, e.g., detecting, parsing, and extracting content from historical records, including through the use of layout detection, handwriting recognition, entity extraction, relationship detection, etc.), or any other suitable tasks.

As illustrated, in some embodiments, the genealogical agentic system 102 can select the function adapter 840 from a function adapter window 848. Specifically, the genealogical agentic system 102 can utilize a function adapter window 848 to determine and select a subset of function adapters 840, 842 that correspond to a context (e.g., a task domain or a query classification) of a particular task or query. The genealogical agentic system 102 can slide or move the function adapter window 848 over different subsets of function adapters, depending on the relevant context. Thus, the genealogical agentic system 102 can select relevant function adapters for executing functions, informing large language models, and/or extracting data for executing respective tasks based on modifying the function adapter window 848 according to the task domain and/or query classification. For instance, the genealogical agentic system 102 could slide the function adapter window 848 to encompass the function adapter 842 and the function adapter 844, excluding the function adapter 840 based on a change in query classification (e.g., from the query classification 818 to the query classification 822).

In some embodiments, rather than generating the function adapter window 848 to include the subset of function adapters 840, 842, the genealogical agentic system 102 can train a large language model (e.g., as part of the classifier node 808) to select relevant function adapters to include in the function adapter window 848.

Further, in some embodiments, the genealogical agentic system 102 can provide a function adapter virtual representation 837 to the task sub-graph 824 and/or the large language model 830 of the task sub-graph 824. The genealogical agentic system 102 can generate the function adapter virtual representation 837 to include a description of the function adapter 836, such as one or more functions the function adapter 836 performs and/or a description of one or more parameters of the function adapter 836. In addition, the genealogical agentic system 102 can generate the function adapter virtual representation 837 to be a description of the function adapter 836 that is specific to the large language model 830. For example, the large language model 830 can be a large language model of the plurality of large language models 501 of FIG. 5 (e.g., a large language model that the genealogical agentic system 102 trains with a specific set of data to perform a specific set of functions). The genealogical agentic system 102 can generate the function adapter virtual representation 837 to include a description of the function adapter 836 that is specific to one or more functionalities of the large language model 830. By generating the function adapter virtual representation 837 specifically for the large language model 830 and providing the function adapter virtual representation 837 to the large language model 830, the genealogical agentic system 102 can enable the large language model 830 to generate an instruction for the function adapter 836 that is specific to the functionalities and/or parameters of the function adapter 836.

Further, in some embodiments, based at least in part on generating the query segments and encapsulating the task sub-graph 824, the task sub-graph 826, and the task sub-graph 828 to create different privacy states among the task sub-graph 824, the task sub-graph 826, and the task sub-graph 828, the genealogical agentic system 102 can determine or otherwise orchestrate a workflow the task 812, the task 816, and the task 820. For example, the genealogical agentic system 102 can determine dependencies among the task 812, the task 816, and the task 820, and determine the workflow according to the dependencies among the task 812, the task 816, and the task 820. To illustrate, the genealogical agentic system 102 can determine that completing the task 816 and the task 820 is dependent upon a response to the task 812. Accordingly, the genealogical agentic system 102 can determine a workflow that includes using the task sub-graph 824 to generate a response to the task 812, and simultaneously (e.g., in parallel)—or alternatively in a sequence one after another—provide the response to the task 812 and the task 816 to the task sub-graph 826 and provide the response to the task 812 and the task 820 to the task sub-graph 828.

Additionally, in some embodiments, the genealogical agentic system 102 can aggregate the response to the task 812, the response to the task 816, and the response to the task 820 to generate an aggregated response to provide to the user account via the client device 800. For example, the genealogical agentic system 102 can generate the aggregated response by using a node and/or a large language model of the genealogical autonomous-decision framework to summarize and combine the response to the task 812, the response to the task 816, and the response to the task 820. In some embodiments, the response task 812, the response to the task 816, and the response to the task 820 can be different potential responses to the query 804 (e.g., the query 804 can be a request to identify an ancestor, and the response task 812, the response to the task 816, and the response to the task 820 can each be potential candidates for the ancestor). Based on identifying the potential candidates, the genealogical agentic system 102 can generate the aggregated response by providing a summary of each of the potential candidates and comparing or otherwise ranking the potential candidates.

Further, the genealogical agentic system 102 can further augment the response (and/or the aggregated response) by utilizing a response augmentation sub-graph to compare the response to the task 812, the response to the task 816, and/or the response to the task 820 (and/or documents or genealogical data related to the responses) to generate new hints (or other genealogical content items or modifications to genealogical trees) for user accounts associated with the genealogical agentic system 102. For example, the genealogical agentic system 102 can utilize (e.g., by comparing or otherwise analyzing) the response to the task 812, the response to the task 816, and/or the response to the task 820 to autonomously generate a hint for the user account (e.g., the user account that the genealogical agentic system 102 receives the query 804 from). In some embodiments, the genealogical agentic system 102 can utilize the response to the task 812, the response to the task 816, and/or the response to the task 820 to autonomously generate a hint for an additional user account.

In some embodiments, the genealogical agentic system 102 can use the large language model 830 can generate an instruction for the function adapter 836 to cause the function adapter to execute or otherwise perform the task 812 and thereby generate a response (or a partial response) to the query. Moreover, genealogical agentic system 102 can use the large language model 830 to provide the instruction to the function adapter 836 to cause the function adapter 836 to extract or otherwise determine genealogical data. Accordingly, the genealogical agentic system 102 can use the function adapter 836 to augment or modify the large language model 830 with additional information (e.g., through generating or modifying a prompt or code for the large language model 830 via the function adapter 836). Based on the large language model 830 receiving the genealogical data, the genealogical agentic system 102 can cause the large language model 830 to augment the genealogical data and generate a response (or a partial response) based on the genealogical data.

Further, the genealogical agentic system 102 can use the task sub-graphs 824, 826, 828 and/or function adapters 836, 838, 840 to generate a plurality of partial responses to the query 804. For example, the genealogical agentic system 102 can use the task sub-graph 824 and/or the function adapter 836 to complete the task 812 and generate a first partial response to the query 804. Additionally, the genealogical agentic system 102 can use the task sub-graph 826 and/or the function adapter 838 to complete the task 816 and generate a second partial response to the query 804. Moreover, the genealogical agentic system 102 can use the task sub-graph 828 and/or the function adapter 840 to complete the task 820 and generate a third partial response to the query 804. Based on generating the plurality of partial responses to the query 804, the genealogical agentic system 102 can combine the plurality of partial responses (e.g., such as by utilizing the genealogical autonomous-decision framework and/or a routing controller of the genealogical autonomous-decision framework to combine the plurality of partial responses) to generate the response to the query 804. The genealogical agentic system 102 can provide the response to the query via the user interface 802 of the client device 800.

Moreover, while FIG. 8 illustrates the task sub-graph 824 communicating with the function adapter 836, the task sub-graph 826 communicating with the function adapter 838, and the task sub-graph 828 communicating with the function adapter 840, the genealogical agentic system 102 is not limited to utilizing a singular task sub-graph to communicate with a singular function adapter. Indeed, in some embodiments, the genealogical agentic system 102 can utilize the task sub-graph 824 to generate an instruction for the function adapter 838 and/or the function adapter 840. Additionally, the genealogical agentic system 102 can enable the plurality of task sub-graphs (e.g., the task sub-graph 824, the task sub-graph 826, and the task sub-graph 828) to communicate with each other, such as by providing updates and/or information pertaining to the respective tasks of each task sub-graph.

That is, while discrete operation of the task sub-graphs 824, 826, 828, large language models 830, 832, 834, and function adapters 836, 838, 840 is depicted, it will be appreciated that the genealogical agentic system 102 is configured in embodiments to permit and rely upon interdependence and/or interoperability of the task sub-graphs 824, 826, 828, large language models 830, 832, 834, and/or function adapters 836, 838, 840. For example, in some embodiments, a first partial response generated by large language model 830 in cooperation with or under direction of task sub-graph 824 and function adapter 836 may be provided with the task 816 to the task sub-graph 826 to inform and improve a corresponding process performed by the large language model 832. For instance, genealogical or relationship predictions by the large language model 830 may beneficially inform the adjacent processes of, e.g., identifying and parsing historical-record content (at, e.g., large language model 830) and/or identifying and parsing genetic relationships (at, e.g., large language model 834). In embodiments, the large language models 830, 832, 834 are not necessarily distinct models but rather one or more may be a same large language model performing different tasks under different directions and/or with different resources.

Further, it will be appreciated that while large language models 830, 832, 834 are depicted as being associated with the respective task sub-graphs 824, 826, 828, the task sub-graphs 824, 826, 828 are not limited to calls to large language models, but rather may be configured to call any suitable tool or API, which may include the use of a large language model but may alternatively include or be configured to cooperate with any suitable utility. Further, while the large language models 830, 832, 834 are depicted as being associated with the respective task sub-graphs 824, 826, 828 in a 1:1 relationship, it will be appreciated that this is merely exemplary and that, in embodiments, any task sub-graph may call or rely upon any tool, such as the large language models 830, 832, 834 or other available utility without limitation.

Thus for example, while one large language model is determined to be particularly well-suited for decisions regarding dates, times, and places, said large language model may be invoked for any task that includes decisions involving, directly or indirectly, dates, times, and/or places. Another large language model may be particularly well-configured for parsing and generating responses regarding the particularized language of genealogical relationships and may be invoked in any task that includes decisions involving, directly or indirectly, genealogical relationships. This allows the genealogical agentic systems of embodiments to be an agentic platform that, rather than being a narrowly focused chatbot, facilitates the dynamic utilization of state-of-the-art utilities, including large language model, specialized databases and repositories, and other tools in response to unpredictable user intents and needs, while providing context-informed decision-making that relies upon a variety of domain-specific knowledge bases and knowledge graphs.

The genealogical agentic systems of embodiments thus facilitate the real-time navigation and utilization of a dynamic ecosystem of tools and capabilities responsive to unpredictable and wide-ranging user queries regarding DNA, family history, and historical research by providing an agentic system that utilizes specialized knowledge bases and chain-of-thought repositories to orchestrate a workflow and generate accurate, detailed responses to genealogical queries.

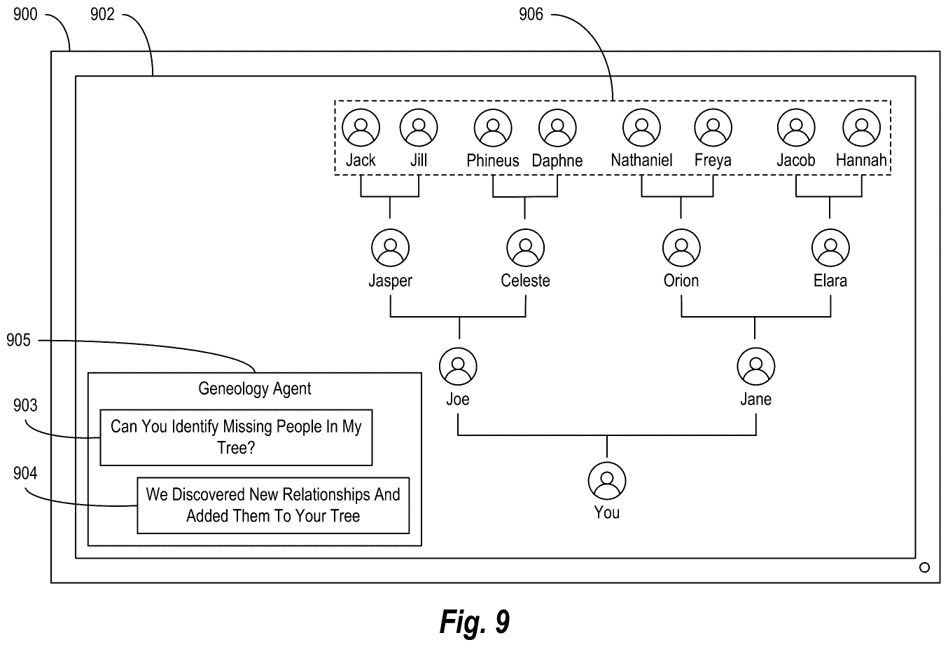

As previously mentioned, the genealogical agentic system 102 can generate a response to a query. FIG. 9 illustrates the genealogical agentic system 102 generating a response to a query and providing genealogical data within a user interface of a client device in accordance with one or more embodiments.

As shown in FIG. 9, the genealogical agentic system 102 can receive a query 903 (e.g., “Can You Identify Missing People In My Tree?”) from a user account within a chat interface 905 (e.g., “Genealogy Agent”). The genealogical agentic system 102 can display the chat interface 905 within a user interface 902 of a client device 900 as an entry point for interacting with, and generating responses and executing genealogical research tasks through, the genealogical autonomous-decision framework described in embodiments herein. As previously discussed, responsive to receiving the query 903, the genealogical agentic system 102 can utilize the genealogical autonomous-decision framework to orchestrate one or more task sub-graphs to extract genealogical data 906 as indicated by the query 903.

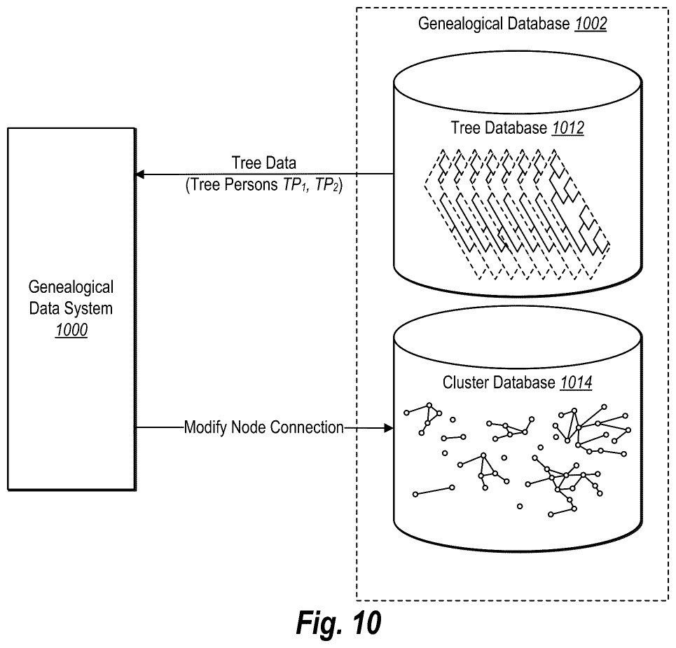

For example, the genealogical agentic system 102 can determine that the query 903 deals with a genealogical tree and identify a genealogical tree corresponding to the user account. The genealogical agentic system 102 can determine one or more genealogical relationships represented by the genealogical tree by identifying tree persons (e.g., genealogical tree nodes) within the genealogical tree and edges that connect the tree persons to the user account. Based on identifying the genealogical relationships represented in the genealogical tree, the genealogical agentic system 102 can utilize one or more task sub-graphs of the genealogical autonomous-decision framework of embodiments to search a tree database (e.g., a tree database 1012 of FIG. 10, discussed below) to identify additional genealogical relationships for the user account (or to provide clarification, correction, and/or improved resolution to existing genealogical relationships). The genealogical agentic system 102 can extract data for the user account from the genealogical tree and utilize the data to iteratively determine genealogical data 906 for the user account. In addition to searching the tree database, the genealogical agentic system 102 can utilize task sub-graphs of the genealogical autonomous-decision framework to execute calls to APIs, to search websites and/or applications, to determine applicable record hints, and/or to determine or Otherwise extract DNA data related to the query, among others.

As shown in FIG. 9, the genealogical agentic system 102 can generate a response 904 (“e.g., “We Discovered New Relationships And Added Them To Your Tree”) to the query 903. The genealogical agentic system 102 can generate the response 904 to describe one or more actions the genealogical agentic system 102 performed as well as indicate information the genealogical agentic system 102 discovered. Further, as part of generating the response 904, the genealogical agentic system 102 can display the genealogical data 906 within the user interface 902. For example, as shown, the genealogical agentic system 102 can display the genealogical data 906 (e.g., a newly added portion of a genealogical tree) by modifying the genealogical tree of the user account to display additional tree persons in the genealogical tree of the user account. Specifically, the genealogical agentic system 102 can display the additional tree persons in the genealogical tree of the user account to indicate genealogical relationships between the user of the user account and individuals corresponding to the tree persons in the genealogical tree.

As an example of generating the response 904, the genealogical agentic system 102 uses a first task sub-graph to determine a number and placement of nodes included in a genealogical tree of the user account (e.g., by using a task adapter to access genealogical tree data via an associated API). The genealogical agentic system 102 additionally uses a second task sub-graph to determine missing nodes within existing branches of the genealogical tree and/or additional branches or nodes for extending the genealogical tree to include more generations. The genealogical agentic system 102 further uses a third task sub-graph to determine and access data from other genealogical trees (e.g., using task adapters to call associated APIs to access information from accounts of relatives of the user according to permission settings and/or from a ground-truth genealogical tree of the genealogical data system 106, by calling a cluster-database API to identify clusters associated with existing and/or potential tree nodes, etc.) to identify, and determine probabilities for, potential individuals for adding to the genealogical tree. The genealogical agentic system 102 still further uses a fourth task sub-graph (and a task adapter) to extract information for one or more individuals who satisfy a threshold probability of belonging to the genealogical tree.

Additionally, the genealogical agentic system 102 can include additional information for the tree persons. For example, responsive to receiving an indication of an interaction with a tree person in the genealogical tree (e.g., such as a tap, click, or swipe with a tree person), the genealogical agentic system 102 can display additional genealogical data within the user interface 902, such as DNA information (e.g., a summation of ancestral DNA types of the individual corresponding to the tree node), BMD data, pertinent historical records or media, associated user accounts and associated genealogical trees, etc. Indeed, the genealogical agentic system 102 can utilize a task adapter to access DNA information from a DNA database (e.g., via an API call) to augment or information a large language model of a task sub-graph classified to determine DNA information for nodes of a genealogical tree.

FIG. 10 illustrates a genealogical data system 1000 (e.g., the genealogical data system 106) interfacing with a genealogical database 1002 in accordance with one or more embodiments. For certain genealogical databases, the genealogical data system 1000 identifies groups of user nodes or records in the format of a genealogical tree or records connected by biological and other family relationships as “tree data.” The genealogical data system 1000 can thus search and process tree data stored in a genealogical database 1002 (which includes a tree database 1012 and a cluster database 1014) to execute tasks and perform functions as described herein.

For the genealogical database 1002, the genealogical data system 1000 may receive genealogical data (e.g., data records and/or genealogical data objects) for building tree data from a source selected from a ground-truth genealogical tree generated from genealogical records and trees of user accounts within the genealogical data system 1000, from the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated. Genealogical data may also include data from a cluster database 1014 derived from records and user data.

Some embodiments of the genealogical agentic system 102 relate to modifying a cluster database 1014 based on a user query and/or other interaction with the genealogical agentic system 102. In some instances, the genealogical data system 1000 (or the genealogical agentic system 102) determines and/or modifies a node connection for an individual represented by or resolved to a cluster within the cluster database 1014. Indeed, the genealogical agentic system 102 can analyze, add, remove, and/or modify genealogical content items organized into clusters within the cluster database 1014 based on relatedness corresponding to a common individual. The genealogical agentic system 102 can also access, modify, and analyze genealogical trees within the tree database 1012 by, for example, adding nodes, removing nodes, and/or modifying nodes based genealogical content items (and their relationships to individuals) stored within the cluster database 1014.

As seen in FIG. 10, the genealogical data system 1000 includes a genealogical database 1002, which may include a tree database 1012 and a cluster database 1014. The tree database 1012 may be configured to facilitate the generation, storage, and collation of family trees for a plurality of users, with trees comprising nodes and edges therebetween. Data and records, such as images, may be associated with individual nodes of the trees in the tree database 1012. Tree person data, including data such as names, relationships, dates, events, and other metadata may be provided by the tree database 1012 to the genealogical data system 1000. The cluster database 1014 may include one or more clusters comprising resolved entities, where tree persons (nodes) in different trees in the tree database 1012 are associated together in a cluster after determination that the tree persons correspond to a same person.

As a user expands their family tree, e.g. by tagging a previously unknown person in an image using the suggestions provided by the ancestor-identification system and adding the now-identified person to their tree as a new node, the tree database 1012 may be modified as the user's family tree is expanded, and the cluster database 1014 may be modified to include the new node in the pertinent cluster. Further, the genealogical agentic system 102 can attach a conversation with a user account (e.g., a query received from the user account and a response the genealogical agentic system 102 generates, and/or a series of queries and corresponding responses) to a cluster within the cluster database 1014 and/or a node within the tree database 1012 to utilize as a ground-truth genealogical tree for future operations within the genealogical data system 1000. For example, the genealogical agentic system 102 can extract or otherwise pull contextual data from the user account or conversations with the user account (e.g., such as the query 408, the clarifying response 410, the follow-on query 412, the status update 414, the instruction 416, the response 418, the second instruction 420, the genealogical data 422, and/or the response 424 of FIG. 4) and attach the context to a node or a cluster of the cluster database 1014 to utilize as a ground-truth genealogical tree for future operations within the genealogical data system 1000 and/or the genealogical agentic system 102.

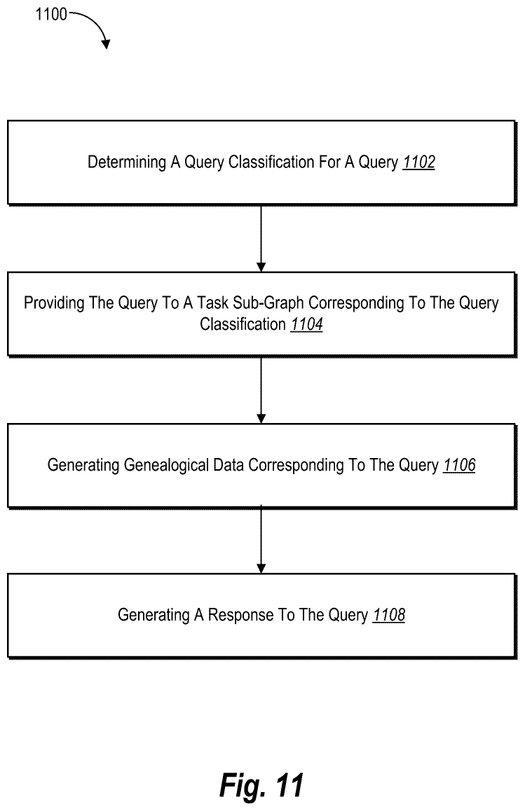

FIGS. 1-10 the corresponding text, and the examples provide a number of different systems and methods for generating responses using a genealogical autonomous-decision framework in accordance with one or more embodiments. In addition to the foregoing, implementations can also be described in terms of flowcharts comprising acts steps in a method for accomplishing a particular result. For example, FIG. 11 illustrates an example series of acts for generating responses using a genealogical autonomous-decision framework.

While FIG. 11 illustrates acts according to certain implementations, alternative implementations may omit, add to, reorder, and/or modify any of the acts shown in FIG. 11. The acts of FIG. 11 can be performed as part of a computer-implemented method. Alternatively, a non-transitory computer-readable medium can comprise instructions, that when executed by one or more processors, cause a computing device to perform the acts of FIG. 11. In still further implementations, a system can perform the acts of FIG. 11.

As illustrated, the series of acts 1100 includes an act 1102 of determining a query classification for a query. Specifically, the act 1102 can include determining, utilizing a classifier node of a genealogical autonomous-decision framework, a query classification for a query received from a client device. Additionally, the series of acts 1100 can include an act 1104 of providing the query to a task sub-graph corresponding to the query classification. Specifically, the act 1104 can include providing, utilizing a routing controller of the genealogical autonomous-decision framework, the query to a task sub-graph corresponding to the query classification within the genealogical autonomous-decision framework. Further, the series of acts 1100 can include an act 1106 of generating genealogical data corresponding to the query. Specifically, the act 1106 can include generating, based on providing the query to the task sub-graph, genealogical data corresponding to the query by utilizing a function adapter corresponding to the task sub-graph. Moreover, the series of acts 1100 can include an act 1108 of generating a response to the query. Specifically, the act 1108 can include generating a response to the query utilizing a large language model of the task sub-graph informed by the generated genealogical data.

In addition, in some embodiments, the series of acts 1100 can include utilizing the large language model to generate, from the query, an instruction for the function adapter to generate the genealogical data.

Moreover, in one or more embodiments, the series of acts 1100 can include identifying a retrieval-augmented-thought (RAT) store item comprising a text description interpretable by the large language model to inform chain-of-thought response generation. Further, the series of acts 1100 can include generating the instruction for the function adapter by utilizing the large language model to execute one or more processes indicated by the RAT store item.

Further, in some embodiments, the series of acts 1100 can include extracting contextual genealogical data from a user account associated with the client device. The series of acts 1100 can also include determining the query classification according to the contextual genealogical data.

Additionally, in one or more embodiments, the series of acts 1100 can include selecting the function adapter from a plurality of function adapters within the genealogical autonomous-decision framework according to the contextual genealogical data of the user account.

Furthermore, in some embodiments, the genealogical autonomous-decision framework can include the routing controller that routes queries among a plurality of large language models arranged in a graph of task sub-graphs corresponding to task domains. Additionally, the genealogical autonomous-decision framework can include a set of function adapters that adapt the plurality of large language models to perform respective functions within the task domains. In addition, the genealogical autonomous-decision framework can include a genealogical database storing genealogical data accessible by the plurality of large language models and the set of function adapters. Further, the genealogical autonomous-decision framework can include a persistence layer that stores query and/or other data for recall in subsequent sessions with the genealogical autonomous-decision framework.

Moreover, in some embodiments, the series of acts 1100 can include determining, by a classifier node of a genealogical autonomous-decision framework, a query classification for a query received from a client device. In addition, the series of acts 1100 can include providing, by a routing controller of the genealogical autonomous-decision framework, the query to a task sub-graph corresponding to the query classification within the genealogical autonomous-decision framework. Further, the series of acts 1100 can include generating, based on providing the query to the task sub-graph, utilizing a large language model of the task sub-graph, an instruction for a function adapter to generate genealogical data corresponding to the query. In addition, the series of acts 1100 can include generating a response to the query utilizing the large language model informed by the genealogical data.

Furthermore, in one or more embodiments, the series of acts 1100 can include parsing the query to determine a plurality of tasks from the query. In addition, the series of acts 1100 can include determining respective query classifications for the plurality of tasks parsed from the query. Moreover, the series of acts can include providing, utilizing the routing controller, the plurality of tasks to corresponding task sub-graphs of the genealogical autonomous-decision framework according to the respective query classifications.

In addition, in some embodiments, the series of acts 1100 can include generating a plurality of task responses utilizing large language models corresponding to the task sub-graphs for the plurality of tasks. Further, the series of acts 1100 can include generating the response to the query by combining the plurality of task responses.

Moreover, in one or more embodiments, the series of acts 1100 can include extract inga plurality of attributes of a tree person. In addition, the series of acts 1100 can include determining a plurality of impactfulness scores corresponding to the plurality of attributes. Further, the series of acts 1100 can include, based on determining that one or more of the plurality of impactfulness scores are above a threshold, generating the response by indicating a relationship between an individual corresponding to the tree person and a user corresponding to a user account of the client device.

Additionally, in some embodiments, the series of acts 1100 can include determining the plurality of impactfulness scores corresponding to the plurality of attributes by determining a Shapley value for each attribute.

Further, in one or more embodiments, the series of acts 1100 can include identifying a retrieval-augmented-thought (RAT) store item comprising a text description interpretable by the large language model to inform chain-of-thought response generation. In addition, the series of acts 1100 can include generating the response to the query by utilizing the large language model to execute one or more processes indicated by the RAT store item.

In addition, in one or more embodiments, the series of acts 1100 can include determining, by a classifier node of a genealogical autonomous-decision framework, a query classification for a query received from a client device based on extracting contextual genealogical data from a user account associated with the client device. Furthermore, the series of acts 1100 can include providing, by a routing controller of the genealogical autonomous-decision framework, based at least in part on the contextual genealogical data, the query to a task sub-graph corresponding to the query classification within the genealogical autonomous-decision framework. Additionally, the series of acts 1100 can include generating, based on providing the query to the task sub-graph and on the contextual genealogical data, genealogical data corresponding to the query by utilizing a function adapter corresponding to the task sub-graph. Further, the series of acts 1100 can include generating a response to the query utilizing a large language model of the task sub-graph informed by the genealogical data.

Moreover, in some embodiments, the series of acts 1100 can include identifying a retrieval-augmented-thought (RAT) store item comprising a text description interpretable by the large language model to inform chain-of-thought response generation. In addition, the series of acts 1100 can include providing the query to the task sub-graph corresponding to the query classification by utilizing a large language model associated with the routing controller to execute one or more processes indicated by the RAT store item.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server(s) 104 and/or the client device 108) that may be configured to perform one or more of the processes described above. One will appreciate that server(s) 104 and/or the client device 108 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to, receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Although this disclosure describes certain exemplary embodiments and examples of a genealogical agentic system, computer program product, and/or method, it nevertheless will be understood by those skilled in the art that the present disclosure extends beyond the specifically disclosed embodiments to other alternative embodiments and/or uses of the disclosure and obvious modifications and equivalents thereof. It is intended that the scope of the present disclosure should not be limited by the particular disclosed embodiments described above, and may be extended to other uses, approaches, and contexts of family tree-, genealogy-, and/or genetic-related applications.

FIG. 13 is a schematic diagram illustrating environment 1300 within which one or more implementations of the genealogical agentic system 102 can be implemented. For example, the genealogical agentic system 102 may be part of a genealogical data system 1302 (e.g., the genealogical data system 106). The genealogical data system 1302 may generate, store, manage, receive, and send digital content (such as genealogical content items). For example, genealogical data system 1302 may send and receive digital content to and from client devices 1306 by way of network 1304. In particular, genealogical data system 1302 can store and manage genealogical databases for various user accounts, historical records, and genealogical trees. In some embodiments, the genealogical data system 1302 can manage the distribution and sharing of digital content between computing devices associated with user accounts. For instance, the genealogical data system 1302 can facilitate a user account sharing a genealogical content item with another user account of genealogical data system 1302.

In particular, the genealogical data system 1302 can manage synchronizing digital content across multiple client devices 1306 associated with one or more user accounts. For example, a user may edit a digitized historical document or a node within a genealogical tree using client device 1306. The genealogical data system 1302 can cause client device 1306 to send the edited genealogical content to the genealogical data system 1302, whereupon the genealogical data system 1302 synchronizes the genealogical content on one or more additional computing devices.

As shown, the client device 1306 may be a desktop computer, a laptop computer, a tablet computer, an augmented reality device, a virtual reality device, a personal digital assistant (PDA), an in-or out-of-car navigation system, a handheld device, a smart phone or other cellular or mobile phone, or a mobile gaming device, other mobile device, or other suitable computing devices. The client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1304.

The network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 may access genealogical data system 1302.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A computer-implemented method comprising:
determining, utilizing a classifier node of a genealogical autonomous-decision framework, a query classification for a query received from a client device, wherein the genealogical autonomous-decision framework comprises:
a routing controller that routes queries among a plurality of large language models arranged in a graph of task sub-graphs according to task domains;
a set of function adapters that adapt the plurality of large language models to perform respective functions within the task domains; and
a genealogical database storing genealogical data accessible by the plurality of large language models and the set of function adapters;
providing, utilizing the routing controller of the genealogical autonomous-decision framework, the query to a task sub-graph of the task sub-graphs corresponding to the query classification within the genealogical autonomous-decision framework;
generating, based on providing the query to the task sub-graph, genealogical data corresponding to the query by utilizing a function adapter of the set of function adapters corresponding to the task sub-graph; and
generating a response to the query utilizing a large language model of the task sub-graph informed by the genealogical data.

2. The computer-implemented method of claim 1, wherein generating the genealogical data utilizing the function adapter comprises utilizing the large language model to generate, from the query, an instruction for the function adapter to generate the genealogical data.

3. The computer-implemented method of claim 2, further comprising:
identifying a retrieval-augmented-thought (RAT) store item comprising a text description interpretable by the large language model to inform chain-of-thought response generation; and
generating the instruction for the function adapter by utilizing the large language model to execute one or more processes indicated by the RAT store item.

4. The computer-implemented method of claim 1, further comprising:
extracting contextual genealogical data from a user account associated with the client device; and
determining the query classification according to the contextual genealogical data.

5. The computer-implemented method of claim 4, further comprising selecting the function adapter from a plurality of function adapters within the genealogical autonomous-decision framework according to the contextual genealogical data of the user account.

6. The computer-implemented method of claim 1, further comprising:
parsing the query to determine a plurality of tasks from the query;
determining respective query classifications for the plurality of tasks parsed from the query; and
providing, utilizing the routing controller, the plurality of tasks to corresponding task sub-graphs of the genealogical autonomous-decision framework according to the respective query classifications.

7. The computer-implemented method of claim 1, wherein the genealogical autonomous-decision framework further comprises a persistence layer that stores query data for recall in subsequent sessions with the genealogical autonomous-decision framework.

8-20. (canceled)

21. A computer-implemented method comprising:
determining, utilizing a classifier node of a genealogical autonomous-decision framework, a query classification for a query received from a client device;
providing, utilizing a routing controller of the genealogical autonomous-decision framework, the query to a task sub-graph corresponding to the query classification within the genealogical autonomous-decision framework;
generating, based on providing the query to the task sub-graph, genealogical data corresponding to the query by utilizing a function adapter corresponding to the task sub-graph by:
identifying a retrieval-augmented-thought (RAT) store item comprising a text description interpretable by a large language model to inform chain-of-thought response generation;
generating, based on the query, an instruction for the function adapter to generate the genealogical data by utilizing the large language model to execute one or more processes indicated by the RAT store item; and
generating a response to the query utilizing a large language model of the task sub-graph informed by the genealogical data.

22. The computer-implemented method of claim 21, further comprising:
parsing the query to determine a plurality of tasks from the query;
determining respective query classifications for the plurality of tasks parsed from the query; and
providing, utilizing the routing controller, the plurality of tasks to corresponding task sub-graphs of the genealogical autonomous-decision framework according to the respective query classifications.

23. The computer-implemented method of claim 22, further comprising:
generating a plurality of task responses utilizing large language models corresponding to the task sub-graphs for the plurality of tasks; and
generating the response to the query by combining the plurality of task responses.

24. The computer-implemented method of claim 23, further comprising:
extracting a plurality of attributes of a tree person;
determining a plurality of impactfulness scores corresponding to the plurality of attributes; and
based on determining that one or more of the plurality of impactfulness scores are above a threshold, generating the response by indicating a relationship between an individual corresponding to the tree person and a user corresponding to a user account of the client device.

25. The computer-implemented method of claim 24, further comprising determining the plurality of impactfulness scores corresponding to the plurality of attributes by determining a Shapley value for each attribute.

26. The computer-implemented method of claim 21, further comprising:
extracting contextual genealogical data from a user account associated with the client device; and
determining the query classification according to the contextual genealogical data.

27. The computer-implemented method of claim 26, further comprising selecting the function adapter from a plurality of function adapters within the genealogical autonomous-decision framework according to the contextual genealogical data of the user account.

28. A computer-implemented method comprising:
extracting contextual genealogical data from a user account associated with a client device;
determining, utilizing a classifier node of a genealogical autonomous-decision framework and according to the contextual genealogical data, a query classification for a query received from a client device;
providing, utilizing a routing controller of the genealogical autonomous-decision framework, the query to a task sub-graph corresponding to the query classification within the genealogical autonomous-decision framework;
selecting, according to the contextual genealogical data of the user account, a function adapter from a plurality of function adapters that corresponds to the task sub-graph within the genealogical autonomous-decision framework;
generating, based on providing the query to the task sub-graph, genealogical data corresponding to the query by utilizing the function adapter corresponding to the task sub-graph; and
generating a response to the query utilizing a large language model of the task sub-graph informed by the genealogical data.

29. The computer-implemented method of claim 28, wherein the genealogical autonomous-decision framework comprises:
the routing controller that routes queries among a plurality of large language models arranged in a graph of task sub-graphs corresponding to task domains;
a set of function adapters that adapt the plurality of large language models to perform respective functions within the task domains; and
a genealogical database storing genealogical data accessible by the plurality of large language models and the set of function adapters.

30. The computer-implemented method of claim 29, wherein the genealogical autonomous-decision framework further comprises a persistence layer that stores query data for recall in subsequent sessions with the genealogical autonomous-decision framework.

31. The computer-implemented method of claim 28, further comprising:
parsing the query to determine a plurality of tasks from the query;
determining respective query classifications for the plurality of tasks parsed from the query; and
providing, utilizing the routing controller, the plurality of tasks to corresponding task sub-graphs of the genealogical autonomous-decision framework according to the respective query classifications.

32. The computer-implemented method of claim 31, further comprising:
generating a plurality of task responses utilizing large language models corresponding to the task sub-graphs for the plurality of tasks; and
generating the response to the query by combining the plurality of task responses.

33. The computer-implemented method of claim 32, further comprising:
extracting a plurality of attributes of a tree person;
determining a plurality of impactfulness scores corresponding to the plurality of attributes by determining a Shapley value for each attribute; and
based on determining that one or more of the plurality of impactfulness scores are above a threshold, generating the response by indicating a relationship between an individual corresponding to the tree person and a user corresponding to a user account of the client device.
